(19) United States
(12) Patent Application Publication
(10) Pub. No.: US 2018/0192409 A1
(43) Pub. Date: Jul. 5, 2018

(54) FREQUENCY SPECTRUM RESOURCE ALLOCATION METHOD AND APPARATUS

(71) Applicant: ZTE CORPORATION, Guangdong (CN)

(72) Inventors: Ling YANG, Guangdong (CN); Wei GOU, Guangdong (CN); Yajun ZHAO, Guangdong (CN); Focai PENG, Guangdong (CN)

(21) Appl. No.: 15/741,212

(22) PCT Filed: Jun. 30, 2016
(86) PCT No.: PCT/CN2016/087977

§ 371 Date: Dec. 29, 2017

(30) Foreign Application Priority Data
Jun. 30, 2015 (CN) 201510374253.X

(51) Int. Cl. H04W 72/04; H04L 5/00

(52) U.S. Cl. CPC H04W 72/044; H04W 16/14; H04L 5/0007; H04L 5/0041

(57) ABSTRACT

A spectrum resource allocation method and apparatus are provided. The method includes: determining a resource allocation pattern of nodes according to a preset parameter, wherein the preset parameter comprises at least one of: a starting position of a frequency domain or an offset of the frequency domain, an ending position of the frequency domain, a length of consecutively allocated resources or a size of consecutively allocated clusters, a number of clusters or a number of resource sets, a period T, a number of multiplexing nodes in frequency domain resources, or a number of allocatable resources in a system; and obtaining a corresponding resource allocation indicator value r by the resource allocation pattern determined by at least one of the preset parameters in a preset encoding mode. The resource allocation indicator value r is used for indicating resource position information allocated to a terminal UE.

### TECHNICAL FIELD

The present disclosure relates to, but is not limited to, the technical field of communications and, in particular, relates to a spectrum resource allocation method and apparatus.

### BACKGROUND

In the evolution of Long-Term Evolution (LTE) in Rel-13, one major subject matter is that the LTE system can work on an unlicensed carrier. This technology will enable the LTE system to use existing unlicensed carriers and greatly enhance potential spectrum resources for the LTE system so that the LTE system can achieve lower spectrum costs.

In addition, according to provisions on resource allocation in the existing 3rd Generation Partnership Project (3GPP) standard, the number of clusters allocated to a terminal is limited to two or less in a manner of inconsecutive resource allocation. To a certain extent, this not only affects the flexibility of scheduling, but also reduces gains brought by frequency diversity.

No effective technology has been provided to solve problems of poor flexibility, high overheads and low frequency diversity gains in resource allocation in the related art.

### SUMMARY

The following is a summary of a subject matter described herein in detail. This summary is not intended to limit the scope of the claims.

An embodiment of the present disclosure provides a spectrum resource allocation method. The method includes: determining a resource allocation pattern of nodes according to a preset parameter, wherein the preset parameter includes at least one of: a starting position of a frequency domain or an offset of the frequency domain, an ending position of the frequency domain, a length of consecutively allocated resources or a size of consecutively allocated clusters, a number of clusters or a number of resource sets, a period T, a number of multiplexing nodes in frequency domain resources, or a number of allocatable resources in a system; and obtaining a corresponding resource allocation indicator value r by the resource allocation pattern determined by at least one of the preset parameters in a preset encoding mode, wherein the resource allocation indicator value r is used for indicating resource position information allocated to a terminal UE.

Alternatively, the number of the allocatable resources in the system is divided into a first number of interleaved units, a first number of clusters, or a first number of resource blocks.

Alternatively, each of the interleaved units or clusters or resource blocks includes a second number of resource units.

Alternatively, between the resource units in each of the interleaved units or clusters or resource blocks have intervals of specific values; or between the resource units in each of the interleaved units or clusters or resource blocks are consecutive resource blocks.

Alternatively, the intervals between the resource units are equal intervals or unequal intervals.

Alternatively, when the intervals between the resource units are equal, each of the intervals is the period T.

Alternatively, between the interleaved units or between the clusters or between the resource blocks, between resource units of the same resource unit index have a specific offset.

Alternatively, the minimum of the offset is zero, the maximum of the offset is the first number or the second number or a preset number.

Alternatively, the period T is at least one of: 1, 2, 3, 4, 5, 6, 7, 8, 9 or 10.

A unit of the preset parameter T is resource block (RB) or resource element (RE) or resource block group (RBG) or sub-band.

Alternatively, the number of the allocatable resources in the system is at least one of: 100, 75, 50 or 25.

A unit of the allocatable resources in the system is RB.

Alternatively, the second number is obtained by dividing the number of the allocatable resources in the system by the period T.

Alternatively, the first number is the period T.

Alternatively, the resource units are resource blocks (RBs) or resource elements (REs) or resource block groups (RBGs) or sub-bands.

Alternatively, the resource allocation pattern includes: a resource allocation pattern in which the minimum granularity of resource allocation is a resource block (RB), or a resource allocation pattern in which the minimum granularity of resource allocation is a resource element (RE). The minimum granularity of resource allocation is related to the granularity of a clear channel assessment (CCA) detection pattern.

Alternatively, the minimum granularity of resource allocation is consistent with the minimum granularity of the CCA detection pattern; or the minimum granularity of resource allocation granularity is inconsistent with the minimum granularity of the CCA detection pattern.

Alternatively, the resource allocation indicator value r is used for the terminal UE obtaining the allocated resource position information through corresponding decoding according to the resource allocation indicator value r, and the resource position information includes: the starting position of the frequency domain, and the length of the consecutively allocated resources; or the starting position of the frequency domain, and the size of the consecutively allocated clusters; or a starting position of the interleaved units or clusters or resource blocks, and the number of consecutively allocated interleaved units or clusters or resource blocks; or the starting position of the frequency domain, and the ending position of frequency domain resources; or a starting position of the interleaved units or clusters or resource blocks, and an ending position of the interleaved units or clusters or resource blocks.

Alternatively, the period T of the clusters, and/or the number of the multiplexing nodes, and/or the number of the clusters, and/or the first number, and/or the second number, and/or the intervals, and/or the offset, and/or the preset number in the resource allocation pattern are/is obtained by at least one of the following modes:

obtaining the period T of the clusters, and/or the number of the multiplexing nodes, and/or the number of the clusters, and/or the first number, and/or the second number, and/or the intervals, and/or the offset, and/or the preset number in the resource allocation pattern through a corresponding relationship with a system bandwidth;

obtaining the period T of the clusters, and/or the number of the multiplexing nodes, and/or the number of the clusters, and/or the first number, and/or the second number, and/or the intervals, and/or the offset, and/or the preset number in the resource allocation pattern through a downlink control information (DCI) indication;

obtaining the period T of the clusters, and/or the number of the multiplexing nodes, and/or the number of the clusters, and/or the first number, and/or the second number, and/or the intervals, and/or the offset, and/or the preset number in the resource allocation pattern through preset value(s); or

obtaining the period T of the clusters, and/or the number of the multiplexing nodes, and/or the number of the clusters, and/or the first number, and/or the second number, and/or the intervals, and/or the offset, and/or the preset number in the resource allocation pattern through value(s) configured by a base station or high layer signaling.

Alternatively, a way of determining the resource allocation indicator value r through the starting position of the frequency domain and the length of the consecutively allocated resources; or the starting position of the frequency domain and the size of the consecutively allocated clusters; or the starting position of the interleaved units or clusters or resource blocks, the number of the consecutively allocated interleaved units or clusters or resource blocks and the number of the allocatable resources, includes at least one of the following modes.

Mode 1:

In a case of the resource allocation pattern in which the minimum granularity of resource allocation is RB, when (L_{CRBs}−1)≤└N_{RB}^{UL}/2┘, then RIV=N_{RB}^{UL} (L_{CRBs}−1)+RB_{START}, and when (L_{CRBs}−1)>└N_{RB}^{UL}/2┘, then RIV=N_{RB}^{UL} (N_{RB}^{UL}−L_{CRBs}+1)+(N_{RB}^{UL}−1−RB_{START}).

L_{CRBs} denotes the length of the consecutively allocated resources or a number of interleaved units or a number of clusters or a number of resource blocks when the minimum granularity of resource allocation is the RB.

N_{RB}^{UL} denotes the number of the allocatable resources when the minimum granularity of resource allocation is the RB.

RB_{START} denotes the starting position of the frequency domain or the starting position of the interleaved units or the starting position of the clusters or the starting position of the resource blocks when the minimum granularity of resource allocation is the RB.

RIV denotes the resource allocation indicator value r.

In a case of the resource allocation pattern in which the minimum granularity of resource allocation is RE, when (L_{Carrier}−1)≤└N_{Carrier}/2┘, then C_RIV=N_{Carrier}(L_{Carrier}−1)+C_{START}, and when (L_{Carrier}−1)>└N_{Carrier}/2┘, then C_RIV=N_{Carrier}(N_{Carrier}−L_{Carrier}+1)+(N_{Carrier}−1−C_{START}).

N_{Carrier} denotes the number of the allocatable resources when the minimum granularity of resource allocation is the RE.

L_{Carrier} denotes the length of the consecutively allocated resources or the number of the interleaved units or the number of the clusters or the number of the resource blocks when the minimum granularity of resource allocation is the RE.

C_{START} denotes the starting position of the frequency domain or the starting position of the interleaved units or the starting position of the clusters or the starting position of the resource blocks when the minimum granularity of resource allocation is the RE.

C_RIV denotes the resource allocation indicator value r.

Mode 2:

In the case of the resource allocation pattern in which the minimum granularity of resource allocation is RB or RE, Y=Mod(x₁*c₁+x₂*c₂,M).

x₁ denotes a starting resource index of a first resource set Cluster, or a starting position index of interleaved units, or a starting position index of clusters or a starting position index of resource blocks.

x₂ denotes the length of consecutively allocated resources of the first resource set Cluster, or the number of the interleaved units, or the number of the clusters, or the number of the resource blocks.

M=m₁*m₂.

m₁, m₂ are mutually prime that is configured by the system by a static or semi-static mode, that is to say, m₁, m₂ are mutually prime within the number of the available resources.

$${c}_{i} = \frac{M}{{m}_{i}} * {( \frac{M}{{m}_{i}} )}^{′} , i = 1 , 2 and {( \frac{M}{{m}_{i}} )}^{′}$$

is a smallest positive integer of satisfying mod (cᵢ,mᵢ)=1.

Y denotes the resource allocation indicator value r.

Alternatively, the resource allocation indicator value r is determined by the ending position of frequency domain and one of the starting position of the frequency domain or the offset of the frequency domain; or is determined by the starting position of the interleaved units or clusters or resource blocks, and the ending position of the interleaved units or clusters or resource blocks, including:

$${r}^{′} = {\sum }_{i = 0}^{{M}^{′} - 1} 〈 \begin{matrix}{N}^{′} - {s}_{i} \\ {M}^{′} - i\end{matrix} 〉 .$$

sᵢ denotes an index of a starting RB or RE resource of frequency domain resources of a resource set Cluster allocated to a user, or the starting position index of the interleaved units or clusters or resource blocks.

sᵢ−1 denotes an index of an ending RB or RE resource of the frequency domain resources of the resource set Cluster allocated to the user, and i=0, 1, or an ending position index of the interleaved units or clusters or resource blocks.

M′ denotes the number of the starting and ending of the resource set Cluster or the interleaved units or clusters or resource blocks. For calculating the resource allocation indicator value r corresponding to the resource set Cluster, M′ is 2.

N′=┌N_{RB}^{UL}/P┐+1.

P denotes a size of a resource block group (RBG), and P is configured according to a corresponding relationship with the system bandwidth or according to resource allocation requirements.

r′ denotes the resource allocation indicator value r.

Alternatively, in the case of the resource allocation pattern in which the minimum granularity of resource allocation is the RB in the mode 1, when the RIV is received by the terminal UE, the terminal UE obtains the starting position RB_{START} of frequency domain resources and the length L_{CRBs} of the allocated consecutive resources, or the starting position RB_{START} of the interleaved units or clusters or resource blocks and the number L_{CRBs} of the allocated consecutive interleaved units or clusters or resource blocks in the resource allocation pattern, including:

calculating a value of X=[RIV/N_{RB}^{UL}]+RIV % N_{RB}^{UL}; determining whether the value of X is less than N_{RB}^{UL}; when the value of X is less than N_{RB}^{UL}, then RBₛₜₐᵣₜ=RIV % N_{RB}^{UL} and L_{CRBs}=[RIV/N_{RB}^{UL}]+1; otherwise, RBₛₜₐᵣₜ=N_{RB}^{UL}−RIV % N_{RB}^{UL}−1 and L_{CRBs}=N_{RB}^{UL}−[RIV/N_{RB}^{UL}]+1.

Alternatively, in the case of the resource allocation pattern in which the minimum granularity of resource allocation is the RE in the mode 1, after receiving the C_RIV, the terminal UE obtains the starting position C_{START} of the allocated subcarriers and the length L_{Carrier} of allocated consecutive subcarriers in the frequency domain in a frequency spectrum, or the starting position C_{START} of the interleaved units or clusters or resource blocks and the number L_{Carrier} of the allocated consecutive interleaved units or clusters or resource blocks, including:

calculating X=[C_RIV/N_{Carrier}]+C_RIV % N_{Carrier}; when X<N_{Carrier}, then (L_{Carrier}−1)≤└N_{Carrier}/2┘, obtaining C_{START}=C_RIV % N_{Carrier} and L_{Carrier}=[C_RIV/N_{Carrier}]+1; otherwise, when X≥N_{Carrier}; then obtaining C_{START}=N_{Carrier}−C_RIV % N_{Carrier}−1 and L_{Carrier}=N_{Carrier}−[C_RIV/N_{Carrier}]+1.

Alternatively, in the mode 2, after receiving the Y, the terminal UE obtains the starting position r₁ of the allocated resources and the length r₂ of the allocated consecutive resources in the frequency domain, or the starting position index r₁ of the interleaved units or clusters or resource blocks, and the number r₂ of the allocated consecutive interleaved units or clusters or resource blocks, including:

$$\begin{matrix}mod ( Y , {m}_{1} ) = {r}_{1} \\ mod ( Y , {m}_{2} ) = {r}_{2} .\end{matrix}$$

r₁ denotes the starting resource index of the allocated resource set Cluster1, or the starting position index of the interleaved units or the starting position index of the clusters or the starting position index of the resource blocks. r₂ denotes the length of the resources of the allocated resources set Cluster1, or the number of the allocated consecutive interleaved units or clusters or resource blocks.

Alternatively, after receiving the r′ sent by a base station, the UE obtains a starting position sᵢ and an ending position sᵢ−1 of each of the clusters or the first cluster, or obtains the starting position sᵢ of the interleaved units or clusters or resource blocks and the ending position sᵢ−1 of the interleaved units or clusters or resource blocks as follows.

In a case that a value of the number of k combinations is r′, then for

$$〈 \begin{matrix}n \\ k\end{matrix} 〉 ,$$

when n=k−1,k,k+1,k+2,L, the value of

$$〈 \begin{matrix}n \\ k\end{matrix} 〉$$

is y₁,y₂,y₃,y₄,y₅,L. According to the value r′ of the number of k combinations, the first value less than r′, such as y₄, is selected. Then corresponding nₖ=k+2, a value of the number of the remaining (k−1) combinations is r′−y₄=r1′, i.e.,

$$〈 \begin{matrix}{n}_{k - 1} \\ k - 1\end{matrix} 〉 .$$

For nₖ₋₁=k−2,k−1,k,k+1, k+2,L, the value of

$$〈 \begin{matrix}{n}_{k - 1} \\ k - 1\end{matrix} 〉$$

is y₁′,y₂′,y₃′,y₄′,y₅′,L, and the first value less than r1′ is selected, and then nₖ₋₁=k. In this way, the UE obtains k resource position indexes allocated by the base station, wherein numbers involved in this case are positive integers.

Alternatively, the resource allocation indicator value r is used for, when the terminal UE receives the corresponding resource allocation indicator value r of the first cluster, or the first interleaved unit or cluster or resource block, or multiple interleaved units or clusters or resource blocks, or a set of interleaved units or clusters or resource blocks, and receives the resource allocation indicator indicated via relatively low bit overheads, obtaining the resource allocation pattern in the entire available resources; or, obtaining the resource allocation pattern with equal interval in the entire available resources by the period T of the clusters and one of the number of the available resources or the number of the clusters.

Alternatively, a bitmap is used to indicate the resource allocation pattern in the entire available resources or the resource position information allocated to the terminal UE.

Another embodiment of the present disclosure further provides a spectrum resource allocation apparatus. The apparatus includes a determining module and an obtaining module.

The determining module is configured to determine a resource allocation pattern of nodes according to a preset parameter, wherein the preset parameter includes at least one of:

a starting position of a frequency domain or an offset of the frequency domain, an ending position of the frequency domain, a length of consecutively allocated resources or a size of consecutively allocated clusters, a number of clusters or a number of resource sets, a period T, a number of multiplexing nodes in frequency domain resources, or a number of allocatable resources in a system.

The obtaining module is configured to obtain a corresponding resource allocation indicator value r by the resource allocation pattern determined by at least one of the preset parameters in a preset encoding mode. The resource allocation indicator value r is used for indicating resource position information allocated to a terminal UE.

Embodiments of the present disclosure further provide a computer-readable storage medium configured to store computer-executable instructions for executing, when executed by a processor, the above-mentioned method.

According to embodiments of the present disclosure, a resource allocation pattern of nodes is determined according to a preset parameter. The preset parameter includes at least one of: a starting position of a frequency domain or an offset of the frequency domain, an ending position of the frequency domain, a length of consecutively allocated resources or a size of consecutively allocated clusters, a number of clusters or a number of resource sets, a period T, a number of multiplexing nodes in frequency domain resources, or a number of allocatable resources in a system. A corresponding resource allocation indicator value r is obtained by the resource allocation pattern determined by at least one of the preset parameters in a preset encoding mode. Based on the resource allocation indicator value r, the position of the frequency domain corresponding to the first cluster allocated to the UE may be obtained, and then combining with the period T of the clusters, the number of multiplexing users or the number of the clusters, the resource pattern, allocated to the UE, on the available resources is determined. This solves problems of poor flexibility, high overheads and low frequency diversity gains in resource allocation caused by a limitation where at most two clusters can be allocated to each user. The method provided by embodiments of the present disclosure can be used to allocate multiple clusters (more than two clusters) to each UE flexibly, thereby increasing flexibility, reducing overheads and improving frequency diversity gains in resource allocation.

Other aspects can be understood after the accompanying drawings and detailed description are read and understood.

### BRIEF DESCRIPTION OF DRAWINGS

FIG. 1 is a flowchart of a spectrum resource allocation method according to an embodiment of the present disclosure.

FIG. 2 is a block diagram of a spectrum resource allocation apparatus according to an embodiment of the present disclosure.

FIG. 3 is a schematic diagram one of resource allocation according to an alternative embodiment of the present disclosure.

FIG. 4 is a schematic diagram two of resource allocation according to an alternative embodiment of the present disclosure.

FIG. 5 is a schematic diagram three of resource allocation according to an alternative embodiment of the present disclosure.

FIG. 6 is a schematic diagram four of resource allocation according to an alternative embodiment of the present disclosure.

FIG. 7 is a schematic diagram five of resource allocation according to an alternative embodiment of the present disclosure.

FIG. 8 is a schematic diagram six of resource allocation according to an alternative embodiment of the present disclosure.

FIG. 9 is a schematic diagram seven of resource allocation according to an alternative embodiment of the present disclosure.

FIG. 10 is a schematic diagram eight of resource allocation according to an alternative embodiment of the present disclosure.

FIG. 11 is a schematic diagram nine of resource allocation according to an alternative embodiment of the present disclosure.

FIG. 12 is a schematic diagram ten of resource allocation according to an alternative embodiment of the present disclosure.

### DETAILED DESCRIPTION

The present disclosure will be described hereinafter in detail with reference to the accompanying drawings in connection with the embodiments. It is to be noted that if not in collision, the embodiments and features therein in the present application may be combined with each other.

It is to be illustrated that the terms “first”, “second” and the like in the description, claims and drawings of the present disclosure are used to distinguish between similar objects and are not necessarily used to describe a particular order or sequence.

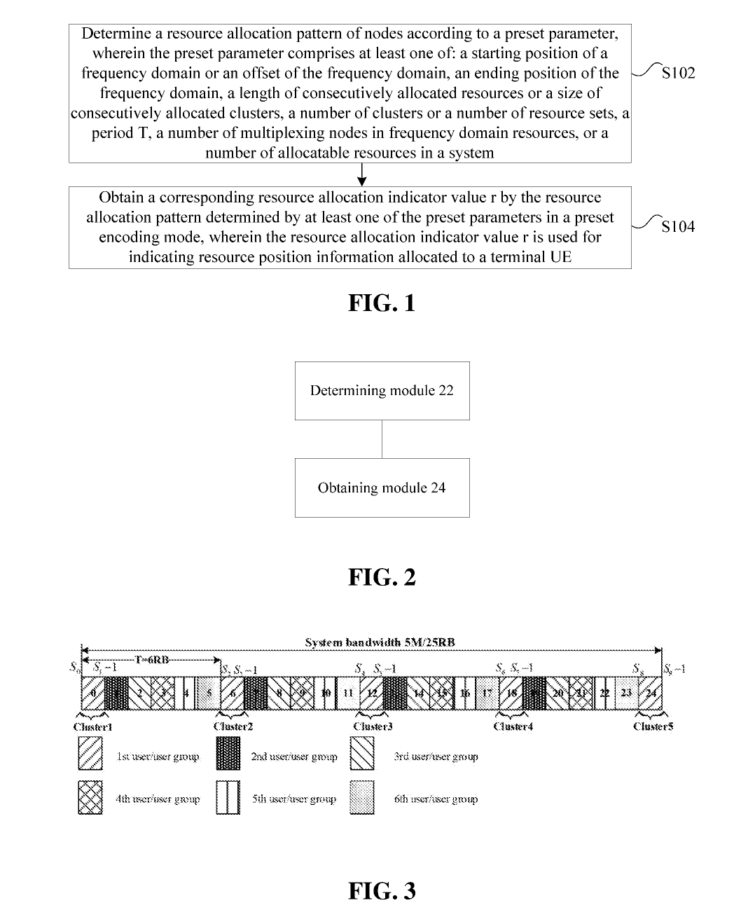

A spectrum resource allocation method is provided in an embodiment. FIG. 1 is a flowchart of a spectrum resource allocation method according to an embodiment of the present disclosure. As illustrated in FIG. 1, the method includes steps described below.

In step S102, a resource allocation pattern of nodes is determined according to a preset parameter, where the preset parameter includes at least one of: a starting position of a frequency domain or an offset of the frequency domain, an ending position of the frequency domain, a length of consecutive allocated resources or a size of clusters, the number of clusters or the number of resource sets, a period T, the number of multiplexing nodes in frequency domain resources, or the number of allocatable resources in the system;

In step S104, a corresponding resource allocation indicator value r is obtained by the resource allocation pattern determined by at least one of the above preset parameters in a preset encoding mode. The resource allocation indicator value r is used for indicating resource position information allocated to a terminal UE.

Through the steps described above, a resource allocation pattern of nodes is determined according to the above preset parameter(s). The preset parameter includes at least one of: the starting position of the frequency domain or the offset of the frequency domain, the ending position of the frequency domain, the length of consecutive allocated resources or the size of clusters, the number of clusters or the number of resource sets, the period T, the number of multiplexing nodes in the frequency domain resources, or the number of the allocatable resources in the system. The corresponding resource allocation indicator value r is obtained by the resource allocation pattern determined by at least one of the above preset parameters in the preset encoding mode. The resource allocation indicator value r can obtain the position of the frequency domain corresponding to the first cluster allocated to the UE, and further determine the resource allocation pattern, that is in the available resources and allocated to the UE, according to the period T of each of the clusters, the number of multiplexing users or the number of the clusters. This solves problems of poor flexibility, high overheads and low frequency diversity gains in resource allocation caused by a limitation where at most two clusters can be allocated to each user. The method provided by the present embodiment can be used to allocate multiple clusters (more than two clusters) to each UE flexibly, thereby increasing flexibility, reducing overheads and improving frequency diversity gains in resource allocation.

In the present embodiment, the resource allocation pattern includes: a resource allocation pattern that the minimum granularity of resource allocation is a resource block (RB), or a resource allocation pattern that the minimum granularity of resource allocation is a resource element (RE).

The minimum granularity of resource allocation is related to the granularity of a clear channel assessment (CCA) detection pattern.

In the present embodiment, the minimum granularity of resource allocation is consistent or inconsistent with the minimum granularity of the CCA detection pattern.

In the present embodiment, the resource allocation indicator value r is used for the terminal UE obtaining the allocated resource position information through corresponding decoding according to the resource allocation indicator value r. The resource position information includes: the starting position of the frequency domain, and the length of the consecutive allocated resources or the size of the clusters; or the starting position of the frequency domain, and the ending position of frequency domain resources.

In the present embodiment, the period T of the clusters, and/or the number of the multiplexing nodes, and/or the number of the clusters in the resource allocation pattern are/is obtained in at least one of the following modes:

obtaining the period T of the clusters, or the number of the multiplexing nodes, or the number of the clusters in the resource allocation pattern through a corresponding relationship with a system bandwidth;

obtaining the period T of the clusters, or the number of the multiplexing nodes, or the number of the clusters in the resource allocation pattern through a downlink control information (DCI) indication;

obtaining the period T of the clusters, or the number of the multiplexing nodes, or the number of the clusters in the resource allocation pattern through pre-setting; or

setting the period T of the clusters, or the number of the multiplexing nodes, or the number of the clusters in the resource allocation pattern as a value which can be configured directly through a base station or high level signaling.

In the present embodiment, the way of determining the resource allocation indicator value r through the starting position of the frequency domain or the offset of the frequency domain, the length of the consecutive allocated resources or the size of the clusters, and the number of the allocatable resources, includes one of the following modes.

Mode 1: In a case of the resource allocation pattern in which the minimum granularity of the resource allocation is the RB:

when (L_{CRBs}−1)≤└N_{RB}^{UL}/2┘, then RIV=N_{RB}^{UL}(L_{CRBs}−1)+RB_{START},

while, when (L_{CRBs}−1)>└N_{RB}^{UL}/2┘, then RIV=N_{RB}^{UL}(N_{RB}^{UL}−L_{CRBs}+1)+(N_{RB}^{UL}−1−RB_{START}).

where L_{CRBs} denotes the length of the consecutive resources when the minimum granularity of resource allocation is the RB; N_{RB}^{UL} denotes the number of the allocatable resources when the minimum granularity of resource allocation is the RB; RB_{START} denotes the starting position of the frequency domain when the minimum granularity of resource allocation is the RB; RIV denotes the resource allocation indicator value r.

In a case of the resource allocation pattern in which the minimum granularity of resource allocation is the RE:

when (L_{Carrier}−1)≤└N_{Carrier}/2┘, then C_RIV=N_{Carrier}(L_{Carrier}−1)+C_{START},

while, when (L_{Carrier}−1)>└N_{Carrier}/2┘, then C_RIV=N_{Carrier}(N_{Carrier}−L_{Carrier}+1)+(N_{Carrier}−1−C_{START}).

where N_{Carrier} denotes the number of the allocatable resources when the minimum granularity of resource allocation is the RE; L_{Carrier} denotes the length of the consecutive resources when the minimum granularity of resource allocation is the RE; C_{START} denotes the starting position of the frequency domain when the minimum granularity of resource allocation is the RE; C_RIV denotes the resource allocation indicator value r.

Mode 2: In the case of the resource allocation pattern in which the minimum granularity of resource allocation is the RB or the RE:

Y=Mod(x₁*c₁+x₂*c₂,M),

where x₁ denotes a starting resource index of the first resource set Cluster; x₂ denotes the length of consecutively allocated resources of the first resource set Cluster; M=m₁*m₂; m₁, m₂ are mutually prime configured in a static mode or a semi-static mode by the system, i.e., m₁, m₂ are mutually prime within the number of the available resources;

$${c}_{i} = \frac{M}{{m}_{i}} * {( \frac{M}{{m}_{i}} )}^{′} , i = 1 , 2 and {( \frac{M}{{m}_{i}} )}^{′}$$

is a smallest positive integer of satisfying mod (cᵢ,mᵢ)=1;

$${( \frac{M}{{m}_{i}} )}^{′}$$

is a conjugate transpose of

$$( \frac{M}{{m}_{i}} ) ;$$

Y denotes the resource allocation indicator value r.

Mode 3: In the present embodiment, determining the resource allocation indicator value r by the starting position of the frequency domain or the offset of the frequency domain, and the ending position of the frequency domain includes:

$${r}^{′} = {\sum }_{i = 0}^{{M}^{′} - 1} 〈 \begin{matrix}{N}^{′} - {s}_{i} \\ {M}^{′} - i\end{matrix} 〉 ,$$

where

$$〈 \begin{matrix}a \\ b\end{matrix} 〉$$

is a symbol of the number of combinations and represents Cₐ^{b}, i.e., the number of combinations formed by taking b elements from a different elements (b≤a);

where sᵢ denotes an index of the starting RB or RE resource of frequency domain resources of the resource set Cluster allocated to a user; sᵢ−1 denotes an index of the ending RB or RE resource of frequency domain resources of the resource set Cluster allocated to the user, and i=0, 1; M′ denotes the number of the starting and ending of the resource set Cluster; and for example, for calculating one resource allocation indicator value r corresponding to that resource set Cluster is calculated, M′ is 2;

N′=┌N_{RB}^{UL}/P┐+1; P denotes the size of a resource block group (RBG), and the size of P is configured according to a corresponding relationship of P and the system bandwidth or according to resource allocation requirements; r′ denotes the resource allocation indicator value r.

In the present embodiment, in the case of the resource allocation pattern in which the minimum granularity of resource allocation is the RB in the mode 1, after receiving the sent RIV, the terminal UE obtains the starting position RB_{START} of frequency domain and the length L_{CRBs} of the allocated consecutive resources in the resource allocation pattern, including:

calculating a value of X=[RIV/N_{RB}^{UL}]+RIV % N_{RB}^{UL};

judging whether the value of X is less than N_{RB}^{UL};

if the value of X is less than N_{RB}^{UL}, then RBₛₜₐᵣₜ=RIV % N_{RB}^{UL} and L_{CRBs}=[RIV/N_{RB}^{UL}]+1;

otherwise, RBₛₜₐᵣₜ=N_{RB}^{UL}−RIV % N_{RB}^{UL}−1 and L_{CRBs}=N_{RB}^{UL}−[RIV/N_{RB}^{UL}]+1.

In the present embodiment, in the case of the resource allocation pattern in which the minimum granularity of resource allocation is the RE in the mode 1, after receiving the C_RIV, the terminal UE obtains the starting position C_{START} of the allocated subcarriers and the length L_{Carrier} of allocated consecutive subcarriers in the frequency domain in a frequency spectrum, including:

calculating a value of X=[C_RIV/N_{Carrier}]+C_RIV % N_{Carrier};

if X<N_{Carrier}, then (L_{Carrier}−1)≤└N_{Carrier}/2┘,

i.e., C_{START}=C_RIV % N_{Carrier} and L_{Carrier}=[C_RIV/N_{Carrier}]+1 can be obtained;

otherwise, if X≥N_{Carrier}, then C_{START}=N_{Carrier}−C_RIV % N_{Carrier}−1 and L_{Carrier}=N_{Carrier}−[C_RIV/N_{Carrier}]+1.

In the present embodiment, in the mode 2, after receiving the value Y, the terminal UE obtains the starting position r₁ of the resources allocated to the UE and the length r₂ of the allocated consecutive resources in the frequency domain, including:

$$\begin{matrix}mod ( Y , {m}_{1} ) = {r}_{1} \\ mod ( Y , {m}_{2} ) = {r}_{2}\end{matrix}$$

where r₁ denotes the starting resource index of the allocated resource set Cluster1; and r₂ denotes the length of the resources of the allocated resources set Cluster1.

Furthermore, after receiving the r′ sent by a base station, the UE can obtain a starting position sᵢ and an ending position sᵢ−1 of each of the clusters or the first cluster, by the following way: if a value of the number of k combinations is r′, then for

$$〈 \begin{matrix}n \\ k\end{matrix} 〉 ,$$

when n=k−1,k,k+1,k+2,L, the value of

$$〈 \begin{matrix}n \\ k\end{matrix} 〉$$

is y₁,y₂,y₃,y₄,y₅,L; according to the value r′ of the number of combinations, the first value, such as y₄, less than r′ is selected, then corresponding nₖ=k+2, and a value of the number of the remaining (k−1) combinations is r′−y₄=r1′, i.e.,

$$〈 \frac{{n}_{k - 1}}{k - 1} 〉 ;$$

for nₖ₋₁=k−2,k−1,k,k+1,k+2,L, the value of

$$〈 \frac{{n}_{k - 1}}{k - 1} 〉$$

is y₁′,y₂′,y₃′,y₄′,y₅′,L, and the first value, such as y₃′, less than r1′ is selected, then nₖ₋₁=k; in this way, the UE obtains k resource position indexes allocated by the base station to the UE, herein the above-mentioned numbers are all positive integers.

In the present embodiment, the resource allocation indicator value r corresponding to the first cluster can be calculated and then indicates the resource allocation by relatively low bit overheads; the resource allocation indicator value r is used for the terminal UE, after receiving the resource indicator r, obtains the resource allocation pattern with equal interval in the entire available resources according to the period T of each of the clusters and one of the number of the available resources or the number of the clusters.

The present embodiment further provides a spectrum resource allocation apparatus for implementing the above embodiments and alternative implementations. What has been described will not be repeated. As used below, the term “module” may be software, hardware or a combination thereof capable of implementing preset functions. The apparatus described in the following embodiment is preferably implemented by software, but implementation by hardware or by a combination of software and hardware is also possible and conceived.

FIG. 2 is a block diagram of a spectrum resource allocation apparatus according to an embodiment of the present disclosure. As illustrated in FIG. 2, the apparatus includes a determining module 22 and an obtaining module 24.

The determining module 22 is configured to determine a resource allocation pattern of nodes according to a preset parameter, wherein the preset parameter comprises at least one of:

a starting position of a frequency domain or an offset of the frequency domain, an ending position of the frequency domain, a length of consecutively allocated resources or a size of consecutively allocated clusters, a number of clusters or a number of resource sets, a period T, a number of multiplexing nodes in frequency domain resources, or a number of allocatable resources in a system.

The obtaining module 24 is configured to obtain a corresponding resource allocation indicator value r by the resource allocation pattern determined by at least one of the preset parameters in a preset encoding mode. The resource allocation indicator value r is used for indicating resource position information allocated to a terminal UE.

Through the apparatus described above, the resource allocation pattern of nodes is determined according to the preset parameter. The preset parameter includes at least one of the following: the starting position of the frequency domain or the offset of the frequency domain, the ending position of the frequency domain, the length of consecutively allocated resources or the size of consecutively allocated clusters, the number of clusters or the number of resource sets, the period T, the number of multiplexing nodes in the frequency domain resources, or the number of allocatable resources in the system. The corresponding resource allocation indicator value r is obtained by the resource allocation pattern determined by at least one of the preset parameters in the preset encoding mode. Though the resource allocation indicator value r a position of frequency domain corresponding to a first cluster allocated to a UE may be obtained, and then the resource allocation pattern, that is on the available resources and allocated to the UE, is determined according to the period T of the clusters, the number of multiplexing users or the number of the clusters. This solves problems of poor flexibility, high overheads and low frequency diversity gains in resource allocation caused by a limitation that at most two clusters can be allocated to each user. The method provided by the present embodiments can be used to allocate multiple clusters (more than two clusters) to each UE flexibly, thereby increasing flexibility, reducing overheads and improving frequency diversity gains in the resource allocation. The present disclosure will be described below in detail in conjunction with alternative embodiments.

The system bandwidth in the present disclosure may be at least one of the following: 5 MHz, 10 MHz, 15 MHz, 20 MHz or greater than 20 MHz. The number of the allocatable resources corresponding to the system bandwidth may be at least one of the following: greater than 100 RBs, 100 RBs, 75 RBs, 50 RBs or 25 RBs.

The number of the allocatable resources in the system is divided into a first number of interleaved units or clusters or resource blocks according to the size of the interleaved units or clusters or resource blocks. For example, if the system bandwidth is 20 MHz and the number of the corresponding allocatable resources is 100 RBs, then, according to the size of 10 of the interleaved units or clusters or resource blocks, the allocatable 100 RBs may be divided into 10 interleaved units or clusters or resource blocks. That is, the allocatable 100 RBs are divided into: an interleaved unit or cluster or resource block 0; an interleaved unit or cluster or resource block 1; an interleaved unit or cluster or resource block 2; an interleaved unit or cluster or resource block 3; an interleaved unit or cluster or resource block 4; an interleaved unit or cluster or resource block 5; an interleaved unit or cluster or resource block 6; an interleaved unit or cluster or resource block 7; an interleaved unit or cluster or resource block 8; and an interleaved unit or cluster or resource block 9.

Each interleaved unit or cluster or resource block includes a second number of resource units, and the second number is a value produced by dividing the number of the allocatable resources in the system by the period T or an interval and then rounded to an integer. For example, if the system bandwidth is 20 MHz and the number of the corresponding allocatable resources is 100 RBs, then, according to the period T or the interval of 10, the allocatable 100 RBs may be divided into 10 interleaved units or clusters or resource blocks, and each interleaved unit or cluster or resource block includes 10 RB resource units. The resource units in each interleaved unit or cluster or resource block may be physically consecutive or discrete with equal intervals or discrete with unequal intervals, or may be logically consecutive or discrete with equal intervals or discrete with unequal intervals.

The intervals between resource units may be the same number of intervals, or may be the different number of intervals. For example, when the intervals between the resource units in the interleaved units or clusters or resource blocks are equal intervals, the interleaved unit or cluster or resource block 0 may be {0, 10, 20, 30, 40, 50, 60, 70, 80, 90}; the interleaved unit or cluster or resource block 1 may be {1, 11, 21, 31, 41, 51, 61, 71, 81, 91}; the interleaved unit or cluster or resource block 2 may be {2, 12, 22, 32, 42, 52, 62, 72, 82, 92}; the interleaved unit or cluster or resource block 3 may be {3, 13, 23, 33, 43, 53, 63, 73, 83, 93}; the interleaved unit or cluster or resource block 4 may be {4, 14, 24, 34, 44, 54, 64, 74, 84, 94}; the interleaved unit or cluster or resource block 5 may be {5, 15, 25, 35, 45, 55, 65, 75, 85, 95}; the interleaved unit or cluster or resource block 6 may be {6, 16, 26, 36, 46, 56, 66, 76, 86, 96}; the interleaved unit or cluster or resource block 7 may be {7, 17, 27, 37, 47, 57, 67, 77, 87, 97}; the interleaved unit or cluster or resource block 8 may be {8, 18, 28, 38, 48, 58, 68, 78, 88, 98}; and the interleaved unit or cluster or resource block 9 may be {9, 19, 29, 39, 49, 59, 69, 79, 89, 99}.

Between the interleaved units, between the clusters or between the resource blocks, between resource units with the same resource unit index have a specific offset. For example, in the above example, an offset of 1 exists between a resource unit with a resource unit index of 0 in the interleaved unit or cluster or resource block 0 and a resource unit with a resource unit index of 0 in the interleaved unit or cluster or resource block 1, and an offset of 1 also exists between a resource unit with a resource unit index of 1 in the interleaved unit or cluster or resource block 0 and a resource unit with a resource unit index of 1 in the interleaved unit or cluster or resource block 1.

### Alternative Embodiment One

With a view to improving flexibility, system performance and application scenarios in resource allocation, the present alternative embodiment provides a novel and improved resource allocation method. The method makes the number of multiplexing nodes in the available spectrum as large as possible, increases an appropriate number of clusters to bring about frequency diversity gains, and adopts corresponding parameters to reduce overheads and calculation complexity to a certain extent.

A problem to be solved by the present alternative embodiment, which provides a resource allocation method, is how to allow each of different UEs/UE groups to have its own resource allocation pattern so as to reduce overheads and complexity and bring about greater frequency diversity gains.

To solve the above problem, the resource allocation method provided by the present alternative embodiment is performed as follows.

A resource allocation pattern of nodes is determined according to at least one of the following parameters:

the starting position of frequency domain or the offset of frequency domain;

the ending position of frequency domain;

the length of consecutively allocated resources or the size of consecutively allocated clusters;

the number of clusters or the number of resource sets;

the period T;

the number of multiplexing nodes in frequency domain resources; or

the number of allocatable resources in the system.

A specific resource allocation pattern is determined based on one or more of the above parameters, and then a value is obtained in a specific encoding mode for indicating the resource allocation.

The resource allocation pattern includes: a resource allocation pattern that the minimum granularity of resource allocation is a resource block (RB), or a resource allocation pattern that the minimum granularity of resource allocation is a resource element (RE). The minimum granularity of the resource allocation (or the size of the clusters in the resource allocation) is related to the granularity of a clear channel assessment (CCA) detection pattern. Alternatively, the minimum granularity of the resource allocation may be consistent with the minimum granularity of the CCA detection pattern. Alternatively, the minimum granularity of the resource allocation may be inconsistent with the minimum granularity of the CCA detection pattern.

The resource allocation indicator value is obtained as follows: a base station encodes the parameter information of the resource pattern to be allocated to a UE to obtain the corresponding resource allocation indication value r.

The UE performs decoding with the received resource allocation indicator value r to obtain the starting position of frequency domain and the length of the consecutively allocated resources or the size of the clusters for the resources allocated to the UE its own, or to obtain the starting position of the frequency domain of the resources and the ending position of the frequency domain resources of one cluster.

The parameter of the period T or the number of the multiplexing nodes or the number of the clusters, which is used to determine the resource allocation pattern, may be predetermined, may be set as a configurable value, may be set a one-to-one corresponding relationship between a specific system bandwidth and one of the period of the clusters or the number of the multiplexing nodes or the number of the clusters, or may be notified through DCI.

The resource allocation indicator value r is determined by the parameters of the starting position of frequency domain or the offset of frequency domain, and the length of the consecutively allocated resources or the size of the clusters, and the number of the allocatable resources, or is determined by the starting position of the interleaved units or clusters or resource blocks, and the number of consecutively allocated interleaved units or clusters or resource blocks, and the number of the allocatable resources, in one of the following modes.

Mode 1:

In a case of the resource allocation pattern in which the minimum granularity of the resource allocation is the RB, the resource allocation indicator value r is calculated as follows:

when (L_{CRBs}−1)≤└N_{RB}^{UL}/2┘, then RIV=N_{RB}^{UL}(L_{CRBs}−1)+RB_{START}; and

when (L_{CRBs}−1)>└N_{RB}^{UL}/2┘, then RIV=N_{RB}^{UL}(N_{RB}^{UL}−L_{CRBs}+1)+(N_{RB}^{UL}−1−RB_{START}).

L_{CRBs} denotes the length of the consecutively allocated resources, or the number of the interleaved units, or the number of the clusters, or the number of the resource blocks when the minimum granularity of the resource allocation is the RB.

N_{RB}^{UL} denotes the number of the allocatable resources when the minimum granularity of the resource allocation is the RB.

RB_{START} denotes the starting position of the frequency domain, or the starting position of the interleaved units, or the starting position of the clusters, or the starting position of the resource blocks when the minimum granularity of the resource allocation is the RB.

RIV (Resource Indicator Value) denotes the resource allocation indicator value r.

In a case of the resource allocation pattern in which the minimum granularity of resource allocation is the RE, the resource allocation indicator value r is:

when (L_{Carrier}−1)≤└N_{Carrier}/2┘, then C_RIV=N_{Carrier}(L_{Carrier}−1)+C_{START}; and

when (L_{Carrier}−1)>└N_{Carrier}/2┘, then C_RIV=N_{Carrier}(N_{Carrier}−L_{Carrier}+1)+(N_{Carrier}−1−C_{START}).

N_{Carrier} denotes the number of the allocatable resources when the minimum granularity of the resource allocation is the RE.

L_{Carrier} denotes the length of the consecutively allocated resources, or the number of the interleaved units, or the number of the clusters, or the number of the resource blocks when the minimum granularity of resource allocation is the RE.

C_{START} denotes the starting position of the frequency domain, or the starting position of the interleaved units, or the starting position of the clusters, or the starting position of the resource blocks when the minimum granularity of the resource allocation is the RE.

C_RIV (Carrier Resource Indicator Value, i.e., SubCarrier-level Resource Indicator Value) denotes a RE-level resource allocation indicator value r.

In the mode 1, the resource allocation indicator value r is indicated to the terminal UE by a type0 mode of uplink resource allocation, and the UE receives the indicator value r sent from the base station by DCI signaling, and can obtain the starting position of the interleaved units or the starting position of the clusters or the starting position of the resource blocks, and the number of the consecutively allocated interleaved units or the number of the clusters or the number of the resource blocks. The UE can obtain the resource allocation pattern on the frequency domain resources through the starting position of the interleaved units or the starting position of the clusters or the starting position of the resource blocks, and the number of the consecutively allocated interleaved units or the number of the clusters or the number of the resource blocks.

Mode 2:

In the case of the resource allocation pattern in which the minimum granularity of resource allocation is the RB or the RE, the resource allocation indicator value r is calculated as follows.

Y=Mod(x₁*c₁+x₂*c₂,M).

x₁ denotes a starting resource index of the first Cluster (resource set), or a starting position index of the interleaved units, or a starting position index of the clusters, or a starting position index of the resource blocks.

x₂ denotes the length of consecutively allocated resources of the first Cluster (resource set), or the number of the interleaved units, or the number of the clusters, or the number of the resource blocks.

Y denotes the resource allocation indicator value r.

m₁,m₂ are mutually prime that is configured by the system in a static mode or semi-static mode (which is notified to the UE through a high layer signaling or a UL grant), i.e., m₁, m₂ are mutually prime within the number of the available resources.

M=m₁*m₂;

$${c}_{i} = \frac{M}{{m}_{i}} * {( \frac{M}{{m}_{i}} )}^{′} , i = 1 , 2 and {( \frac{M}{{m}_{i}} )}^{′}$$

is a smallest positive integer of satisfying mod (cᵢ,mᵢ)=1.

In the case of the resource allocation pattern in which the minimum granularity of the resource allocation is the RB in the mode 2, after receiving the RIV sent by the base station, the UE obtains the starting position RB_{START} of the frequency domain and the length L_{CRBs} of the allocated consecutive resources, or the starting position RB_{START} of the interleaved units or clusters or resource blocks and the number L_{CRBs} of the allocated consecutive interleaved units or clusters or resource blocks of the resource allocation pattern, which includes the following flow.

A value of X=[RIV/N_{RB}^{UL}]+RIV % N_{RB}^{UL} is calculated.

Whether the value of X is less than N_{RB}^{UL} is determined.

If the value of X is less than N_{RB}^{UL}, then RBₛₜₐᵣₜ=RIV % N_{RB}^{UL} and L_{CRBs}=[RIV/N_{RB}^{UL}]+1;

Otherwise, RBₛₜₐᵣₜ=N_{RB}^{UL}−RIV % N_{RB}^{UL}−1 and L_{CRBs}=N_{RB}^{UL}−[RIV/N_{RB}^{UL}]+1.

Similarly, in the case of the resource allocation pattern in which the minimum granularity of resource allocation is the RE in the mode 2, after receiving the C_RIV sent by the base station, the terminal UE obtains the starting position C_{START} of subcarriers and the length L_{Carrier} of allocated consecutive subcarriers in a subcarrier-level resource allocation pattern, or the starting position C_{START} of the interleaved units or clusters or resource blocks and the number L_{Carrier} of allocated consecutive interleaved units or clusters or resource blocks, which includes the following flow.

X=[C_RIV/N_{Carrier}]+C_RIV % N_{Carrier} is calculated.

if X<N_{Carrier}, then (L_{Carruer}−1)≤└N_{Carrier}/2┘, i.e., C_{START}=C_RIV % N_{Carrier} and L_{Carrier}=[C_RIV/N_{Carrier}]+1 may be acquired.

Otherwise, if X≥N_{Carrier}, then C_{START}=N_{Carrier}−C_RIV % N_{Carrier}−1 and L_{Carrier}=N_{Carrier}−[C_RIV/N_{Carrier}]+1.

In the mode 2, after receiving the Y sent by the base station, the UE obtains the starting position r₁ of allocated resources and the length r₂ of the allocated consecutive resources in the frequency domain, or the starting position index r₁ of the interleaved units or clusters or resource blocks and the number r₂ of the allocated consecutive interleaved units or clusters or resource blocks, which includes the following flow.

$$\begin{matrix}mod ( Y , {m}_{1} ) = {r}_{1} \\ mod ( Y , {m}_{2} ) = {r}_{2}\end{matrix} .$$

r₁ denotes the starting resource index of the allocated Cluster1, or the starting position index of the interleaved units, or the starting position index of the clusters, or the starting position index of the resource blocks; and r₂ denotes the length of the resources of the allocated Cluster1, or the number of the allocated consecutive interleaved units, or the number of the clusters, or the number of the resource blocks.

The resource indicator value r is determined by the parameters of the starting position of frequency domain or the offset of frequency domain, and the ending position of frequency domain; or the starting position of the interleaved units or clusters or resource blocks, and the ending position of the interleaved units or clusters or resource blocks by a following mode three:

$${r}^{′} = {\sum }_{i = 0}^{{M}^{′} - 1} 〈 \begin{matrix}{N}^{′} - {s}_{i} \\ {M}^{′} - i\end{matrix} 〉 .$$

sᵢ denotes a starting RB or RE resource index of the frequency domain resources of the Cluster allocated to a user, or the starting position index of the interleaved units or clusters or resource blocks.

sᵢ−1 denotes an index of an ending RB or RE resource of the frequency domain resources of the Cluster allocated to the user, and i=0, 1, or an ending position index of the interleaved units or clusters or resource blocks.

M′ denotes the number of the starting and ending of the Cluster set, and here for just calculating the r corresponding to the one Cluster, M′ is 2.

N′=┌N_{RB}^{UL}/P┐+1.

P denotes a size of a resource block group (RBG). (P may be configured according to a corresponding relationship between P and bandwidths in LTE or may be configured flexibly according to resource allocation requirements.

r′ denotes the resource indicator value r.

In the mode 3, after receiving the value r′ sent by the base station, the UE may obtain a starting position sᵢ and an ending position sᵢ−1 of each of the clusters or the first cluster, or may obtain the starting position s of the interleaved units or clusters or resource blocks and the ending position sᵢ−1 of the interleaved units or clusters or resource blocks, by the following means: if a value of the number of k combinations is r′, then for

$$〈 \begin{matrix}n \\ k\end{matrix} 〉 ,$$

when n=k−1,k,k+1,k+2,L, the value of

$$〈 \begin{matrix}n \\ k\end{matrix} 〉$$

is y₁,y₂,y₃,y₄,y₅,L; according to the value r′ of the number of combinations, the first value, such as y₄, less than r′ is selected, then corresponding nₖ=k+2, and a value of the number of the remaining (k−1) combinations is r′−y₄=r1′, i.e.,

$$〈 \begin{matrix}{n}_{k - 1} \\ k - 1\end{matrix} 〉 ;$$

for nₖ₋₁=k−2,k−1,k,k+1,k+2,L, the value of

$$〈 \begin{matrix}{n}_{k - 1} \\ k - 1\end{matrix} 〉$$

is y₁′,y₂′,y₃′,y₄′,y₅′,L, and the first value, such as y₃′, less than r1′ is selected, then nₖ₋₁=k; in this way, the UE obtains k resource position indexes allocated by the base station to the UE.

Through the above three modes, the resource indicator value may be obtained by calculating, in which the resource indicator value corresponds to the first cluster, or the first interleaved unit or cluster or resource block, or multiple interleaved units or clusters or resource blocks, or a set of the interleaved units or clusters or resource blocks. Compared to calculation of the resource indicator values corresponding to multiple clusters (more than two clusters), the method of calculating the resource position indicator value that corresponds to one cluster, or corresponds to one interleaved unit or cluster or resource block, or corresponds to multiple interleaved units or clusters or resource blocks, or corresponds to a set of the interleaved units or clusters or resource blocks, and/or introducing the parameter of the period or the number of the clusters or the number of the multiplexing nodes, can effectively save bit overheads, reduce calculation complexity and bring about greater frequency diversity gains. That is, after receiving the resource indicator value, the UE obtains the resource allocation pattern on the entire available resources or obtains the resource allocation pattern with equal intervals on the entire available resources according to the period T of each cluster appearing and the number of the available resources or the number of the clusters.

Here the period T, the number of the available resources and the number of the clusters may all be directly obtained through the corresponding relationship with the system bandwidths without extra bit overheads.

In the case where the number of clusters allocated to the user is greater than 2, as well as the intervals between the clusters are not the same or the sizes of the clusters are different, the number of bits required for the resource indicator information may be large and even go beyond the number of bits allocated for the resource indicator information in the existing standards. Hence, this problem may be solved through one of the modes described below.

In Mode one, a new DCI format is defined to satisfy the number of bits required for indicating corresponding to multiple clusters.

In Mode two, the number of bits used by some indicators for indicating irrelevant to the LTE-U system in the existing protocol is allocated to the user for performing the resource indicator information. For example, if an uplink does not need to perform power control and adjustment or send a DMRS (demodulation reference signal), 2 bits allocated to TPC in Format 4 and 3 bits of CS and OCC of DMRS, and so on, may serve as bits for indicating resource positions for multiple clusters.

With the above methods, one or more consecutive resource blocks or interleaved units or clusters are allocated to each user. The consecutive resource blocks or interleaved units or clusters may be physically or logically consecutive. Physically consecutive resource blocks may be construed to mean that the allocated resources are consecutive in the time or frequency dimension. Logically consecutive resource blocks may be construed to mean that the allocated resource blocks are virtual resource blocks and have consecutive resource block indexes. These virtual resource blocks and real physical resource blocks have a fixed mapping relation. Therefore, the real physical resource blocks can become consecutive through the specific mapping relation.

Additionally, in the above methods, the starting position of the frequency domain which is allocated to each user may start from the minimum resource position corresponding to the frequency domain resource index on the corresponding bandwidth (e.g., from index 0), or may start from a resource corresponding to a specific resource index in the middle of the frequency domain.

The present alternative embodiment provides a spectrum resource allocation method. The method may be used to flexibly obtain resource patterns with equal intervals or unequal intervals regarding to consecutive and inconsecutive RB-level resource allocation and subcarrier-level resource allocation. Moreover, due to adoption of the parameter of the period, the method further reduces system overheads, reduces calculation complexity and brings about greater frequency diversity gains.

The alternative embodiment of the present disclosure further provides a method for allocating frequency domain resources, such as RB or subcarrier resources, or resources in a pattern with discrete frequency domains and equal intervals, or resources in a pattern with discrete frequency domains and unequal intervals. Furthermore, the number of allocated discrete resources (the number of the clusters) is greater than 2. The alternative embodiment of the present disclosure focuses on resource allocation of RBs, and assumes some relatively reasonable parameters for specific description. However, the actual application is not limited to the allocation of RBs and the parameter values assumed in the embodiments, and may also involve allocation of subcarriers and assume other reasonable parameter values.

In the present disclosure, the number of the interleaved units or clusters or resource blocks corresponds to the period T in the embodiments. The size of the interleaved units or clusters or resource blocks is a value produced by dividing the number of RBs corresponding to the system bandwidth by the period T and then rounded to an integer, or is a value produced by dividing the number of RBs corresponding to the system bandwidth by the size of the interleaved units or clusters or resource blocks and then rounded to an integer. The resource unit in the interleaved unit or cluster or resource block corresponds to the cluster in the embodiment.

### Alternative Embodiment Two

FIG. 3 is a schematic diagram one of resource allocation according to an alternative embodiment of the present disclosure. As illustrated in FIG. 3, in the resource allocation pattern, the system bandwidth is 5 MHz=25 RBs, and the period T of clusters corresponding to the system bandwidth of 5 MHz is 6 RBs, or the number of the clusters is 5. It needs to be illustrated that the corresponding relationship between the system bandwidth and the period of the clusters or the number of the clusters may be specified in advance. In the alternative embodiment, the starting resource index of the frequency domain of the clusters is 0 by default, but is not limited to the default value, and may be a specific resource in the middle of the resources of the frequency domain.

In the present embodiment, the size of the interleaved units or clusters or resource blocks is a value produced by dividing 25 RBs by the period of 6 RBs and then rounded to 4. The number of the interleaved units or clusters or resource blocks is 6 RBs. The resource units in the interleaved unit or cluster or resource block 0 are {cluster1 (corresponding to RB#0), cluster2 (corresponding to RB#6), cluster3 (corresponding to RB#12), cluster4 (corresponding to RB#18)}. The resource units in the interleaved unit or cluster or resource block 1 are {cluster1 (corresponding to RB#1), cluster2 (corresponding to RB#7), cluster3 (corresponding to RB#13), cluster4 (corresponding to RB#19)}. The resource units in the interleaved unit or cluster or resource block 2 are {cluster1 (corresponding to RB#2), cluster2 (corresponding to RB#8), cluster3 (corresponding to RB#14), cluster4 (corresponding to RB#20)}. The resource units in the interleaved unit or cluster or resource block 3 are {cluster1 (corresponding to RB#3), cluster2 (corresponding to RB#9), cluster3 (corresponding to RB#15), cluster4 (corresponding to RB#21)}. The resource units in the interleaved unit or cluster or resource block 4 are {cluster1 (corresponding to RB#4), cluster2 (corresponding to RB#10), cluster3 (corresponding to RB#16), cluster4 (corresponding to RB#22)}. The resource units in the interleaved unit or cluster or resource block 5 are {cluster1 (corresponding to RB#5), cluster2 (corresponding to RB#11), cluster3 (corresponding to RB#17), cluster4 (corresponding to RB#23)}.

An indicator value r may be obtained through the starting position of the interleaved units or clusters or resource blocks (i.e., the No. of the interleaved unit or cluster or resource block as 0 or 1 or 2 or 3 or 4 or 5 described here), and the number of the consecutively allocated interleaved units or clusters or resource blocks. The base station notifies the UE of the indicator value r. The UE may obtain the resource allocation pattern according to the starting position of the interleaved units or clusters or resource blocks (i.e., the No. of the interleaved unit or cluster or resource block as 0 or 1 or 2 or 3 or 4 or 5 described here) and the number of the consecutively allocated interleaved units or clusters or resource blocks. Furthermore, the resource units in each of the interleaved units or clusters or resource blocks may be predetermined by the base station or the UE, or may be notified by the base station to the UE through a physical layer DCI signaling, or may be notified to the UE through a RRC signaling.

The RB allocation is used as an example to describe the implementation of the resource allocation pattern in detail below. It is assumed that the frequency domain resources pattern allocated to a user 1 or a user group 1 is RB#0, RB#6, RB#12, RB#18 and RB#24, as illustrated in FIG. 3. To reduce resource indication overheads, the period T is adopted here. The resource allocation pattern on the entire frequency domain may be obtained by just acquiring the position of the first cluster and then in conjunction with the period T. Furthermore, the period T (or the number of the multiplexing users or the number of the clusters) and the system bandwidth are in a one-to-one corresponding relationship. The UE may obtain the period T according to the size of the system bandwidth. Here it is assumed that the 5 MHz bandwidth corresponds to a period T of 6.

For the UE side, after receiving the resource indicator value r corresponding to the first cluster sent by the base station, the UE by a corresponding decoding may obtain the staring position of the clusters in the frequency domain and the length of the allocated consecutive resources, or obtain the staring position and ending position of the clusters in the frequency domain.

The value of r may be obtained in mode 1 as follows:

when (L_{CRBs}−1)≤└N_{RB}^{UL}/2┘, then RIV=N_{RB}^{UL}(L_{CRBs}−1)+RB_{START}; and

when (L_{CRBs}−1)>└N_{RB}^{UL}/2┘, then RIV=N_{RB}^{UL} (N_{RB}^{UL}−L_{CRBs}+1)+(N_{RB}^{UL}−1−RB_{START}).

That is to say, when L_{CRBs}=1, N_{RB}^{UL}=25 and RB_{START}=0, then RIV=N_{RB}^{UL}(L_{CRBs}−1)+RB_{START}=0. When receiving an RIV the value of which is 0, the UE may acquire that the resource position index of the first cluster is RB#0, and then, combining with the period T=6 implied by the system bandwidth, the UE may obtain the frequency domain resource pattern of: RB#0, RB#6, RB#12, RB#18 and RB#24.

The value of r may be obtained in mode 3 as follows:

$$r = {\sum }_{i = 0}^{{M}^{′} - 1} 〈 \begin{matrix}{N}^{′} - {s}_{i} \\ {M}^{′} - i\end{matrix} 〉 ,$$

where, N′=┌N_{RB}^{UL}/P┐+1, and N′ and M′ in the above equation may be different from or the same as N, M and P given in uplink resource allocation in the existing physical layer standard. Here, P is 2, N′=┌N_{RB}^{UL}/P┐+1=[25/2]+1=14 and M′=2, then

$$r = {\sum }_{i = 0}^{{M}^{′} - 1} 〈 \begin{matrix}{N}^{′} - {s}_{i} \\ {M}^{′} - i\end{matrix} 〉 = {\sum }_{i = 0}^{1} 〈 \begin{matrix}14 - {s}_{i} \\ 2 - i\end{matrix} 〉 = 〈 \begin{matrix}14 \\ 2\end{matrix} 〉 + 〈 \begin{matrix}13 \\ 1\end{matrix} 〉 = 104.$$

In this case,

$$⌈ {log}_{2} ( ( \begin{matrix}⌈ {N}_{RB}^{UL} / P + 1 ⌉ \\ {M}^{′}\end{matrix} ) ) ⌉ = {log}_{2} ( \begin{matrix}14 \\ 2\end{matrix} ) = 7 bits$$

are required for transmitting the resource indicator value corresponding to the first cluster.

$$( \begin{matrix}14 \\ 2\end{matrix} )$$

represents a number of combinations C₁₄².

Furthermore, the resource position corresponding to the first cluster, which is obtained by decoding the value r, is the first RBG0. Here the first RB in each of the RBGs is allocated to that user or user group, and then combining with the acquired period T (a value of the period in units of RBs), the positions of the resource pattern allocated to the user or user group may be obtained and the positions are: the first RB resource in RBG#0, RBG#3, RBG#6, RBG#9 and RBG#12, so as to allocate to that user or user group.

$$⌈ {log}_{2} ( ( \begin{matrix}⌈ {N}_{RB}^{UL} / P + 1 ⌉ \\ M\end{matrix} ) ) ⌉ = {log}_{2} ( \begin{matrix}14 \\ 10\end{matrix} ) = 10 bits$$

are needed when resource allocation Type2 in the existing physical layer protocol is used to indicate resource position information of multiple clusters.

Therefore, it can be seen that, when the period T is adopted, bit overheads and calculation amount may further decrease.

The value r obtained in the mode 2 is Y=Mod(x₁*c₁+L₁*c₂,M), where m₁=14, m₂=9 (where m₁,m₂ are two mutually primes within the number of the available resource configured by the system), M=m₁*m₂=14*9=126, c₁=99, c₂=28, x₁=0, L₁=1. Then Y=Mod(x₁*c₁+L₁*c₂, M)=28. After the user or user group receives the value of Y, decoding is performed using the following equation:

$$\begin{matrix}mod ( Y , {m}_{1} ) = mod ( 28 , 14 ) = 0 = {r}_{1} \\ mod ( Y , {m}_{2} ) = mod ( 28 , 9 ) = 1 = {r}_{2}\end{matrix} .$$

r₁ indicates that the starting point of the allocated Cluster1 is 0. r₂ indicates that the length of the allocated Cluster1 is 1. Overheads for indicating one cluster are

$$⌈ {log}_{2} ( {\prod }_{i = 1}^{2 P} {m}_{i} ) ⌉ = [ {log}_{2} ( {m}_{1} * {m}_{2} ) ] = [ {log}_{2} ( 126 ) ] = 7 bits .$$

Furthermore, since the period of the clusters may be obtained according to the system bandwidth, the position information of multiple cluster sets allocated to the user or user group in the frequency domain may be obtained. If the period T is not adopted, the number of values of m may be required to be defined as 6 mutually primes (i.e., starting positions of 5 clusters correspond to five values of m, and one value of m is required if the lengths of all the clusters are same, so a total of 6 parameters m are required), then bit overheads for indicating the allocation pattern for the entire frequency domain are

$$⌈ {log}_{2} ( {\prod }_{i = 1}^{2 P} {m}_{i} ) ⌉ = [ {log}_{2} ( {m}_{1} * {m}_{2} * {m}_{3} * {m}_{4} * {m}_{5} * {m}_{6} ) ] bits .$$

When the parameter of the period is adopted, system overheads decrease significantly.

In the present embodiment, relationships among the period T, the number of multiplexing users and the size of the clusters are that: the number of the multiplexing users may be uniquely determined according to the period T and the size of the clusters, or the period of the clusters of a user may be determined according to the product of the number of multiplexing users and the size of the clusters. That is, any two of the above three parameters may determine the third parameter. Through different combinations of these three parameters, it is possible to obtain various resource allocation patterns on the corresponding bandwidths. Furthermore, the number of the clusters may also be acquired based on the system bandwidth and the corresponding period (The premise is that, when the starting resource index of the clusters in the frequency domain is 0 and other allocated starting resource indexes are not 0, the number of the clusters allocated to a certain user or user group can also be obtained from the system bandwidth minus the resource index corresponding to the staring position of frequency domain and then divided by the period). Positions of the resource pattern may correspond one by one to positions of CCA Pattern frequency domain pattern adopted when the node for CCA detection performs the CCA detection, and whether the minimum granularity of resources in each cluster in resource allocation is RB or RE is determined according to the minimum granularity of resource detection in the CCA detection pattern.

The three modes for obtaining the resource indicator value corresponding to the first cluster according to the present embodiment can all be used. In the embodiments described below, one of the three modes may be just selected to describe different resource allocation patterns.

### Alternative Embodiment Three

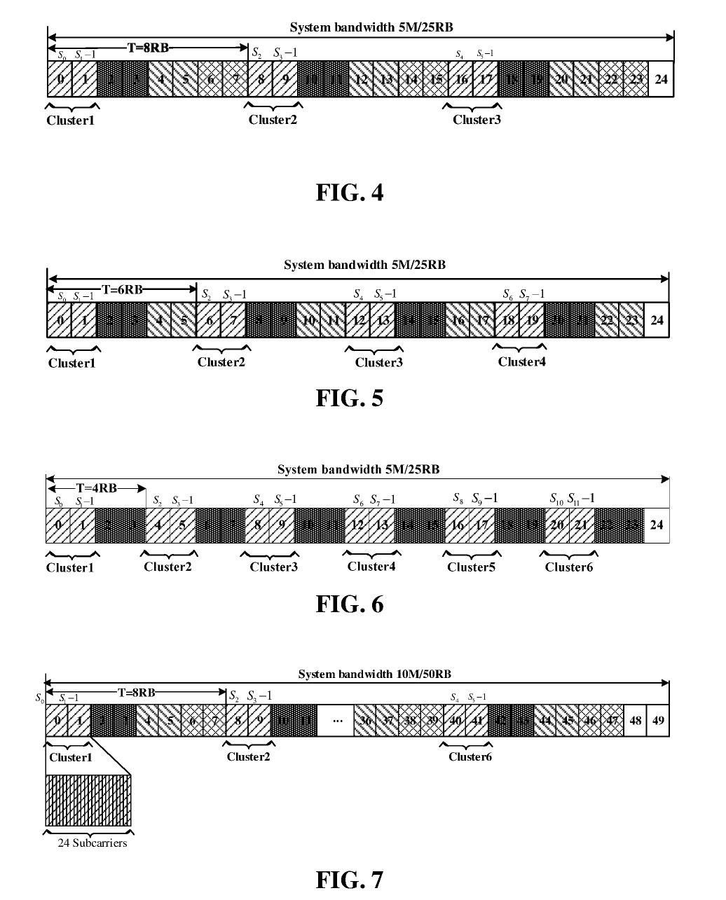

FIG. 4 is a schematic diagram two of resource allocation according to an alternative embodiment of the present disclosure. As illustrated in FIG. 4, in the resource allocation pattern, the system bandwidth is 5 MHz=25 RBs, and the period T of clusters corresponding to the system bandwidth of 5 MHz is 8 RBs, or the number of the clusters is 3. It needs to be illustrated that the corresponding relationship between the system bandwidth and the period of the clusters or the number of the clusters may be specified in advance. The size of each cluster is 2 RBs (i.e., the size of one RBG). In the embodiment, the starting resource index of the frequency domain of the clusters is 0 by default, but is not limited to the default value, and may be a specific resource in the middle of the resources of the frequency domain.

The RB allocation is used as an example to describe the implementation of the resource allocation pattern in detail below. It is assumed that the frequency domain resources pattern allocated to a user 1 or a user group 1 is RBG#0, RBG#4 and RBG#8, as illustrated in FIG. 4. To reduce resource indication overheads, the period T is adopted here. The resource allocation pattern on the entire frequency domain may be obtained by just acquiring the position of the first cluster and then in conjunction with the period T. Furthermore, the period T (or the number of the multiplexing users or the number of the clusters) and the system bandwidth are in a one-to-one corresponding relationship. The UE may obtain the period T according to the size of the system bandwidth. Here it is assumed that the 5 MHz bandwidth corresponds to a period T of 8.

For the UE side, after receiving the resource indicator value r corresponding to the first cluster sent by the base station, the UE by a corresponding decoding may obtain the staring position of the clusters in the frequency domain and the length of the allocated consecutive resources, or obtain the staring position and ending position of the clusters in the frequency domain.

The value of r may be obtained in mode 3 as follows:

$$r = {\sum }_{i = 0}^{{M}^{′} - 1} 〈 \begin{matrix}{N}^{′} - {s}_{i} \\ {M}^{′} - i\end{matrix} 〉 ,$$

where, N′=┌N_{RB}^{UL}/P┐+1, and N′ and M′ in the above equation may be different from or the same as N, M and P given in uplink resource allocation in the existing physical layer standard. Here, P is 2, N′=┌N_{RB}^{UL}/P┐+1=[25/2]+1=14 and M′=2, then

$$r = {\sum }_{i = 0}^{{M}^{′} - 1} 〈 \begin{matrix}{N}^{′} - {s}_{i} \\ {M}^{′} - i\end{matrix} 〉 = {\sum }_{i = 0}^{1} 〈 \begin{matrix}14 - {s}_{i} \\ 2 - i\end{matrix} 〉 = 〈 \begin{matrix}14 \\ 2\end{matrix} 〉 + 〈 \begin{matrix}13 \\ 1\end{matrix} 〉 = 104.$$

In this case,

$$⌈ {log}_{2} ( ( \begin{matrix}⌈ {N}_{RB}^{UL} / P + 1 ⌉ \\ {M}^{′}\end{matrix} ) ) ⌉ = {log}_{2} ( \begin{matrix}14 \\ 2\end{matrix} ) = 7 bits$$

are required for transmitting the resource indicator value corresponding to the first cluster.

Furthermore, the value r is decoded as follows: for

$$〈 \begin{matrix}n \\ 2\end{matrix} 〉 ,$$

when n=1, 2, 3, 4, 5, . . . , values of

$$〈 \begin{matrix}n \\ 2\end{matrix} 〉$$

are 0, 1, 3, 6, 10, 15, 21, 28, 36, 45, 55, 66, 78, 91, 105 and 120. The first value less than 104 is selected to be 91, here the value of n is 14. The value of the number of remaining combinations is 104−91=13, i.e.

$$〈 \begin{matrix}{n}_{1} \\ 1\end{matrix} 〉 .$$

When n₁=0, 1, 2, 3, . . . , values of

$$〈 \begin{matrix}{n}_{1} \\ 1\end{matrix} 〉$$

are 0, 1, 2, 3, . . . , 24, 25. The first value that is less than or equal to 13 is selected to be 13, where the value of n₁ is 13. Therefore, the resource position of the first cluster may be obtained as RBG#0 according to the two of numbers of combinations 14 and 13, and the value of N′. In conjunction with the period T (the value of the period in units of RBs) obtained according to the system bandwidth, the positions of the resource pattern allocated to the user or user group may be obtained as RBG#0, RBG#4, and RBG#8.

$$⌈ {log}_{2} ( ( \begin{matrix}⌈ {N}_{RB}^{UL} / P + 1 ⌉ \\ M\end{matrix} ) ) ⌉ = {log}_{2} ( \begin{matrix}14 \\ 6\end{matrix} ) = 12 bits$$

are needed when resource allocation Type2 in the existing physical layer protocol is used to indicate resource position information of multiple clusters. Therefore, it can be seen that, when the period T is adopted, bit overheads and calculation amount may further decrease.

The value r obtained in the mode 2 is Y=Mod(x₁*c₁+L₁*c₂,M), where m₁=14, m₂=9 (where m₁, m₂ are two mutually primes within the number of the available resource configured by the system), M=m₁*m₂=14*9=126, c₁=99, c₂=28, x₁=0, L₁=2. Then Y=Mod(x₁*c₁+L₁*c₂, M)=56. After the user or user group receives the value of Y, decoding is performed using the following equation:

mod(Y,m₁)=mod(56,14)=0=r₁

mod(Y,m₂)=mod(56,9)=2=r₂

r₁ indicates that the starting point of the allocated Cluster1 is 0. r₂ indicates that the length of the allocated Cluster1 is 2 RBs. Overheads for indicating one cluster are

$$⌈ {log}_{2} ( {\prod }_{i = 1}^{2 P} {m}_{i} ) ⌉ = [ {log}_{2} ( {m}_{1} * {m}_{2} ) ] = [ {log}_{2} ( 126 ) ] = 7 bits .$$

Furthermore, since the period of the clusters may be obtained according to the system bandwidth, the position information of multiple cluster sets allocated to the user or user group in the frequency domain may be obtained. If the period T is not adopted, the number of values of m may be required to be defined as 4 mutually primes (i.e., starting positions of 3 clusters correspond to three values of m, and one value of m is required if the lengths of all the clusters are same, so a total of 4 parameters m are required), then bit overheads for indicating the allocation pattern for the entire frequency domain are

$$⌈ {log}_{2} ( {\prod }_{i = 1}^{2 P} {m}_{i} ) ⌉ = [ {log}_{2} ( {m}_{1} * {m}_{2} * {m}_{3} * {m}_{4} ) ] bits .$$

When the parameter of the period is adopted, system overheads decrease significantly. Furthermore, system overheads can be reduced to a certain extent when values m that are mutually prime are properly selected.

It is to be illustrated that, according to the multiplexing users, the size and the number of clusters allocated to each user, resources that remain on the corresponding system bandwidth and are not allocated to users may be allocated to the previous user adjacent to the remaining resources or allocated to the next user adjacent to a user corresponding to the remaining resources, or may make that resources vacant.

### Alternative Embodiment Four

FIG. 5 is a schematic diagram three of resource allocation according to an alternative embodiment of the present disclosure. As illustrated in FIG. 5, in the resource allocation pattern, the system bandwidth is 5 MHz=25 RBs, and the period T of clusters corresponding to the system bandwidth of 5 MHz is 6 RBs, or the number of the clusters is 4. It needs to be illustrated that the corresponding relationship between the system bandwidth and the period of the clusters or the number of the clusters may be specified in advance. The size of each cluster is 2 RBs. In the embodiment, the starting resource index of the frequency domain of the clusters is 0 by default, but is not limited to the default value, and may be a specific resource in the middle of the resources of the frequency domain.

The RB allocation is used as an example to describe the implementation of the resource allocation pattern in detail below. It is assumed that the frequency domain resources pattern allocated to a user 1 or a user group 1 is RBG#0, RBG#3, RBG#6 and RBG#9, as illustrated in FIG. 5. To reduce resource indication overheads, the period T is adopted here. The resource allocation pattern on the entire frequency domain may be obtained by just acquiring the position of the first cluster and then in conjunction with the period T. Furthermore, the period T (or the number of the multiplexing users or the number of the clusters) and the system bandwidth are in a one-to-one corresponding relationship. The UE may obtain the period T according to the size of the system bandwidth. Here it is assumed that the 5 MHz bandwidth corresponds to a period T of 6 RBs.

For the UE side, after receiving the resource indicator value r corresponding to the first cluster sent by the base station, the UE by a corresponding decoding may obtain the staring position and ending position of the clusters in the frequency domain.

The value of the resource indicator value r may be obtained in mode 3 as follows:

$$r = {\sum }_{i = 0}^{{M}^{′} - 1} 〈 \begin{matrix}{N}^{′} - {s}_{i} \\ {M}^{′} - i\end{matrix} 〉 ,$$

where, N′=┌N_{RB}^{UL}/P┐+1, and N′ and M′ in the above equation may be different from or the same as N, M and P given in uplink resource allocation in the existing physical layer standard. Here, P is 2, N′=┌N_{RB}^{UL}/P┐+1=[25/2]+1=14 and M′=2, then

$$r = {\sum }_{i = 0}^{{M}^{′} - 1} 〈 \begin{matrix}{N}^{′} - {s}_{i} \\ {M}^{′} - i\end{matrix} 〉 = {\sum }_{i = 0}^{1} 〈 \begin{matrix}14 - {s}_{i} \\ 2 - i\end{matrix} 〉 = 〈 \begin{matrix}14 \\ 2\end{matrix} 〉 + 〈 \begin{matrix}13 \\ 1\end{matrix} 〉 = 104.$$

In this case,

$$⌈ {log}_{2} ( ( \begin{matrix}⌈ {N}_{RB}^{UL} / P + 1 ⌉ \\ {M}^{′}\end{matrix} ) ) ⌉ = {log}_{2} ( \begin{matrix}14 \\ 2\end{matrix} ) = 7 bits$$

are required for transmitting the resource indicator value corresponding to the first cluster.

Furthermore, the value r is decoded as follows: for

$$〈 \begin{matrix}n \\ 2\end{matrix} 〉 ,$$

when n=1, 2, 3, 4, 5, . . . , values of

$$〈 \begin{matrix}n \\ 2\end{matrix} 〉$$

are 0, 1, 3, 6, 10, 15, 21, 28, 36, 45, 55, 66, 78, 91, 105 and 120. The first value less than 104 is selected to be 91, here the value of n is 14. The value of the number of remaining combinations is 104−91=13, i.e.

$$〈 \begin{matrix}{n}_{1} \\ 1\end{matrix} 〉 .$$

When n₁=0, 1, 2, 3, . . . , values of

$$〈 \begin{matrix}{n}_{1} \\ 1\end{matrix} 〉$$

are 0, 1, 2, 3, . . . , 24, 25. The first value that is less than or equal to 13 is selected to be 13, where the value of n₁ is 13. Therefore, the resource position of the first cluster may be obtained as RBG#0 according to the two of numbers of combinations 14 and 13 and the value of N. In conjunction with the period T (the value of the period in units of RBs) obtained by the system bandwidth, the positions of the resource pattern allocated to the user or user group may be obtained as RBG#0, RBG#3, RBG#6 and RBG#9.

While resource allocation Type2 in the existing physical layer protocol is used, it is needed to calculate the value r corresponding to the four clusters of RBG#0, RBG#3, RBG#6 and RBG#9, as follows in detail.

$$r = {\sum }_{i = 0}^{M - 1} 〈 \begin{matrix}N - {s}_{i} \\ M - i\end{matrix} 〉 .$$

The starting resource index of the Cluster1 is S₀=0, the ending resource index of the Cluster1 is S₁−1=0, and then S₁=1. The starting resource index of the Cluster2 is S₂=3, the ending resource index of the Cluster2 is S₃−1=3, and then S₃=4. The starting resource index of the Cluster3 is S₄=6, the ending resource index of the Cluster3 is S₅−1=6, and then S₅=7. The starting resource index of the Cluster4 is S₆=9, the ending resource index of the Cluster4 is S₇−1=9, and then S₇=10.

N=┌N_{RB}^{UL}/P┐+1=[25/2]+1=14, and M=8.

$$r = {\sum }_{i = 0}^{M - 1} 〈 \begin{matrix}N - {s}_{i} \\ M - i\end{matrix} 〉 = 〈 \begin{matrix}14 \\ 8\end{matrix} 〉 + 〈 \begin{matrix}13 \\ 7\end{matrix} 〉 + 〈 \begin{matrix}11 \\ 6\end{matrix} 〉 + 〈 \begin{matrix}10 \\ 5\end{matrix} 〉 + 〈 \begin{matrix}8 \\ 4\end{matrix} 〉 + 〈 \begin{matrix}7 \\ 3\end{matrix} 〉 + 〈 \begin{matrix}5 \\ 2\end{matrix} 〉 + 〈 \begin{matrix}4 \\ 1\end{matrix} 〉 = 5552$$

is obtained by substituting the above parameters into r. It can be seen that calculation amount is large and calculation complexity is high when the value r is calculated in the related art. Furthermore,

$$⌈ {log}_{2} ( ( \begin{matrix}⌈ {N}_{RB}^{UL} / P + 1 ⌉ \\ M\end{matrix} ) ) ⌉ = {log}_{2} ( \begin{matrix}14 \\ 8\end{matrix} ) = 12 bits$$

are required for indicating the resource position information of the multiple clusters.

Five more bits are used for transmitting the resource indicator information as compared to the method of the present alternative embodiment in which the period T is adopted. it can be seen that bit overheads and calculation amount may further decrease when the period T is adopted.

Similarly, the above pattern may also be obtained using the mode 1 and the mode 2 in the present disclosure. Moreover, the period of the clusters or the number of multiplexing nodes or the number of the clusters are adopted, thus the same resource allocation pattern may be obtained by just calculating the resource indicator value corresponding to the first cluster and using less system overheads.

It is to be illustrated that, according to the multiplexing users, the size and the number of clusters allocated to each user, resources that remain on the corresponding system bandwidth and are not allocated to users may be allocated to the previous user adjacent to the remaining resources or allocated to the next user adjacent to a user corresponding to the remaining resources, or may make that resources vacant.

### Alternative Embodiment Five

FIG. 6 is a schematic diagram four of resource allocation according to an alternative embodiment of the present disclosure. As illustrated in FIG. 6, in the resource allocation pattern, the system bandwidth is 5 MHz=25 RBs, and the period T of clusters corresponding to the 5 MHz system bandwidth is 4 RBs, or the number of the clusters is 6. It needs to be illustrated that the corresponding relationship between the system bandwidth and the period of the clusters or the number of the clusters may be specified in advance. The size of each cluster is 2 RBs. In the embodiment, the starting resource index of the frequency domain of the clusters is 0 by default, but is not limited to the default value, and may be a specific resource in the middle of the resources of the frequency domain.

Similarly, the RB allocation is used as an example to describe the implementation of the resource allocation pattern in detail. It is assumed that the frequency domain resources pattern allocated to a user 1 or a user group 1 is RBG#0, RBG#2, RBG#4, RBG#6, RBG#8, and RBG#10, as illustrated in FIG. 6.

To reduce resource indication overheads, the period T is adopted here. The resource allocation pattern on the entire frequency domain may be obtained by just acquiring the position of the first cluster and then in conjunction with the period T. As in the alternative embodiment four, the value r corresponding to the first cluster is calculated to be 104, and the overheads are only 7 bits. While the equation in the existing standard is used,

$$⌈ {log}_{2} ( ( \begin{matrix}⌈ {N}_{RB}^{UL} / P + 1 ⌉ \\ M\end{matrix} ) ) ⌉ = {log}_{2} ( \begin{matrix}14 \\ 12\end{matrix} ) = 7 bits$$

are required. From the perspective of bit overheads, in the case where the system bandwidth is 5 MHz=25 RBs and the number of the clusters is 6, the bit overheads used for indicating these resource positions are equal. However, from the perspective of calculation complexity, the calculation using the equation in the existing standard is much more complex than the calculation using the equation provided by the present disclosure where the value r corresponding to one cluster is calculated and then the resource allocation pattern is obtained in conjunction with the period information.

It is to be illustrated that, according to the multiplexing users, the size and the number of clusters allocated to each user, resources that remain on the corresponding system bandwidth and are not allocated to users may be allocated to the previous user adjacent to the remaining resources or allocated to the next user adjacent to a user corresponding to the remaining resources, or may make that resources vacant.

### Alternative Embodiment Six

FIG. 7 is a schematic diagram five of resource allocation according to an alternative embodiment of the present disclosure. As illustrated in FIG. 7, in the resource allocation pattern of the present alternative embodiment, the system bandwidth is 10 MHz=50 RBs (or 600 subcarriers), and the period T of clusters corresponding to the 10 MHz system bandwidth is 8 RBs (96 subcarriers), or the number of the clusters is 6. It needs to be illustrated that the corresponding relationship between the system bandwidth and the period of the clusters or the number of the clusters may be specified in advance. The size of each cluster is 3 RBs for the 10 MHz bandwidth according to the existing standard. In the present embodiment, the size of the clusters is configured as 2 RBs or 24 subcarriers. Here a 1-bit indication message may be used to indicate that the size of the clusters is 2, or the corresponding relation between the system bandwidth and the period may be used to imply that the size of the clusters is 2. In the present embodiment, the starting resource index of the frequency domain of the clusters is 0 by default, but is not limited to the default value, and may be a specific resource in the middle of the resources of the frequency domain.

Similarly, the RB allocation is used as an example to describe the implementation of the resource allocation pattern in detail (the case of subcarriers may also be implemented using the modes described below). It is assumed that the frequency domain resources pattern allocated to a user 1 or a user group 1 is RBG#0, RBG#4, RBG#8, RBG#12, RBG#16, and RBG#20, as illustrated in FIG. 7.

The resource indicator value sent by the base station to the UE may be obtained in the following modes described below.

Mode 1:

when (L_{CRBs}−1)≤└N_{RB}^{UL}/2┘, then RIV=N_{RB}^{UL}(L_{CRBs}−1)+RB_{START}; and

when (L_{CRBs}−1)>└N_{RB}^{UL}/2┘, then RIV=N_{RB}^{UL} (N_{RB}^{UL}−L_{CRBs}+1)+(N_{RB}^{UL}−1−RB_{START}).

That is, when L_{CRBs}=2, N_{RB}^{UL}=20 and RB_{START}=0 then RIV=N_{RB}^{UL}(L_{CRBs}−1)+RB_{START}=50*1+0=50. After the UE receives the RIV with a value of 50 and performs decoding, the decoding process is as follows.

X=[RIV/N_{RB}^{UL}]+RIV % N_{RB}^{UL}=1 is first calculated, and if X is less than N_{RB}^{UL}, then RBₛₜₐᵣₜ=RIV % N_{RB}^{UL}=0 and L_{CRBs}=[RIV/N_{RB}^{UL}]+1=2. It is obtained that the resource position index of the first cluster is RB#0 and RB1 (i.e., RBG#0), and then in conjunction with the period T=8 RBs (i.e., 4 RBGs, where the size of each RBG is 2) impliedly obtained according to the system bandwidth, the frequency domain resource pattern may be obtained to be RBG#0, RBG#4, RBG#8, RBG#12, RBG#16 and RBG#20 or RB#0, RB#1, RB#8, RB#9, RB#16, RB#17, RB#24, RB#25, RB#32, RB#33, RB#40 and RB#41. The number of bits required for transmitting the resource indication information is 6 bits, or 110010 indicated by a bitmap.

Adopting the mode 3, the resource indicator value of the first cluster is calculated using the equation

$$r = {\sum }_{i = 0}^{{M}^{′} - 1} 〈 \begin{matrix}{N}^{′} - {s}_{i} \\ {M}^{′} - i\end{matrix} 〉 ,$$

where s₀=0, s₁=0, i.e., s₁=1, M′=2, and N′=┌N_{RB}^{UL}/P┐+1=[50/2]+1=26, then the value r corresponding to the cluster1 is 350, and the number of required bits is

$$⌈ {log}_{2} ( ( \begin{matrix}⌈ {N}_{RB}^{UL} / P + 1 ⌉ \\ M\end{matrix} ) ) ⌉ = {log}_{2} ( \begin{matrix}26 \\ 2\end{matrix} ) = 9.$$

While the equation in the existing standard is used to calculate the resource indicator value corresponding to all cluster sets,

$$⌈ {log}_{2} ( ( \begin{matrix}⌈ {N}_{RB}^{UL} / P + 1 ⌉ \\ M\end{matrix} ) ) ⌉ = {log}_{2} ( \begin{matrix}26 \\ 12\end{matrix} ) = 24 bits$$

are required. The bit overheads required for latter are about three times larger than the bit overheads required for the mode provided by the present disclosure, and thus can hardly meet the existing DCI format. If resources of multiple cluster are to be indicated, a new DCI format needs to be provided to meet the requirements of allocating multiple clusters to the UE.

Mode 2: The resource indicator value of the first cluster is calculated using the equation Y=Mod(x₁*c₁+L₁*c₂,M), where m1=11, m2=3, M=33, c1=12, c2=22, x1=0, and x2=2, then Y=11. After the UE obtains the value of Y, the UE performs decoding, and the decoding process is as follows:

$$\begin{matrix}mod ( Y , {m}_{1} ) = mod ( 11 , 11 ) = 0 = {r}_{1} \\ mod ( Y , {m}_{2} ) = mod ( 11 , 3 ) = 2 = {r}_{2}\end{matrix} .$$

r₁ indicates that the starting point of the allocated Cluster1 is 0. r₂ indicates that the length of the allocated Cluster1 is 2.

$$⌈ {log}_{2} ( {\prod }_{i = 1}^{2 P} {m}_{i} ) ⌉ = [ {log}_{2} ( {m}_{1} * {m}_{2} ) ] = [ {log}_{2} ( 33 ) ] = 6 bits$$

are required. If the period is not adopted,

$$⌈ {log}_{2} ( {\prod }_{i = 1}^{2 P} {m}_{i} ) ⌉ = [ {log}_{2} ( {m}_{1} * {m}_{2} * {m}_{3} * {m}_{4} * {m}_{5} * {m}_{6} * {m}_{7} ) ] = bits$$

are required for depicting the entire resource allocation pattern. Apparently, more bits are required as compared to the mode where the period is adopted.

Therefore, it can be seen from the three modes, when resources of the multiple clusters are allocated to the user or user group, adopting the period reduces system overheads and calculation complexity significantly.

It is to be illustrated that, according to the multiplexing users, the size and the number of clusters allocated to each user, resources that remain on the corresponding system bandwidth and are not allocated to users may be allocated to the previous user adjacent to the remaining resources or allocated to the next user adjacent to a user corresponding to the remaining resources, or may make that resources vacant.

### Alternative Embodiment Seven

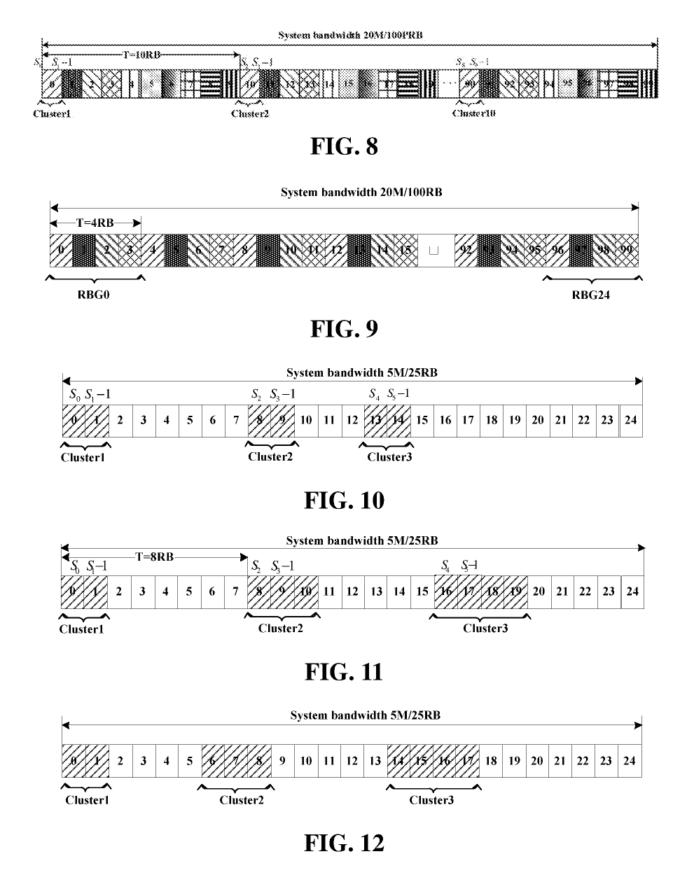

FIG. 8 is a schematic diagram six of resource allocation according to an alternative embodiment of the present disclosure. As illustrated in FIG. 8, in the resource allocation pattern of the present alternative embodiment, the system bandwidth is 20 MHz=100 RBs, and the period T of clusters corresponding to the 20 MHz system bandwidth is 10 RBs, or the number of the clusters is 10. It needs to be illustrated that the corresponding relationship between the system bandwidth and the period of the clusters or the number of the clusters may be specified in advance. The size of the cluster is 4 RBs for the 20 MHz bandwidth according to the existing standard. In the present embodiment, the size of the clusters is configured as 1 RB. Here, the size of the clusters may be indicated to be 1 impliedly according to the corresponding relationship between the system bandwidth and the period or by adopting a 1-bit indication message. In the present embodiment, the starting resource index of the frequency domain of the clusters is 0 by default, but is not limited to the default value, and may be a specific resource in the middle of the resources of the frequency domain.

Similarly, the RB allocation is used as an example to describe the implementation of the resource allocation pattern in detail (the case of subcarriers may also be implemented by using the following means). It is assumed that the pattern of the frequency domain resources allocated to a user 1 or a user group 1 is RB#0, RB#10, RB#20, RB#30, RB#40, RB#50, RB#60, RB#70, RB#80 and RB#90, as illustrated in FIG. 8.

Specifically, in the present embodiment, the size of the interleaved units or clusters or resource blocks is a value produced by dividing 100 RBs by the period of 10 RBs and then rounded to 10. The number of the interleaved units or clusters or resource blocks is 10 RBs.

The resource units in the interleaved unit or cluster or resource block 0 are {cluster1 (corresponding to RB#0), cluster2 (corresponding to RB#10), cluster3 (corresponding to RB#20), cluster4 (corresponding to RB#30), cluster5 (corresponding to RB#40), cluster6 (corresponding to RB#50), cluster7 (corresponding to RB#60), cluster8 (corresponding to RB#70), cluster9 (corresponding to RB#80) and cluster10 (corresponding to RB#90)}.

The resource units in the interleaved unit or cluster or resource block 1 are {cluster1 (corresponding to RB#1), cluster2 (corresponding to RB#11), cluster3 (corresponding to RB#21), cluster4 (corresponding to RB#31), cluster5 (corresponding to RB#41), cluster6 (corresponding to RB#51), cluster7 (corresponding to RB#61), cluster8 (corresponding to RB#71), cluster9 (corresponding to RB#81) and cluster10 (corresponding to RB#91)}.

The resource units in the interleaved unit or cluster or resource block 2 are {cluster1 (corresponding to RB#2), cluster2 (corresponding to RB#12), cluster3 (corresponding to RB#22), cluster4 (corresponding to RB#32), cluster5 (corresponding to RB#42), cluster6 (corresponding to RB#52), cluster7 (corresponding to RB#62), cluster8 (corresponding to RB#72), cluster9 (corresponding to RB#82) and cluster10 (corresponding to RB#92)}.

The resource units in the interleaved unit or cluster or resource block 3 are {cluster1 (corresponding to RB#3), cluster2 (corresponding to RB#13), cluster3 (corresponding to RB#23), cluster4 (corresponding to RB#33), cluster5 (corresponding to RB#43), cluster6 (corresponding to RB#53), cluster7 (corresponding to RB#63), cluster8 (corresponding to RB#73), cluster9 (corresponding to RB#83) and cluster10 (corresponding to RB#93)}.

The resource units in the interleaved unit or cluster or resource block 4 are {cluster1 (corresponding to RB#4), cluster2 (corresponding to RB#14), cluster3 (corresponding to RB#24), cluster4 (corresponding to RB#34), cluster5 (corresponding to RB#44), cluster6 (corresponding to RB#54), cluster7 (corresponding to RB#64), cluster8 (corresponding to RB#74), cluster9 (corresponding to RB#84) and cluster10 (corresponding to RB#94)}.

The resource units in the interleaved unit or cluster or resource block 5 are {cluster1 (corresponding to RB#5), cluster2 (corresponding to RB#15), cluster3 (corresponding to RB#25), cluster4 (corresponding to RB#35), cluster5 (corresponding to RB#45), cluster6 (corresponding to RB#55), cluster7 (corresponding to RB#65), cluster8 (corresponding to RB#75), cluster9 (corresponding to RB#85) and cluster10 (corresponding to RB#95)}.

The resource units in the interleaved unit or cluster or resource block 6 are {cluster1 (corresponding to RB#6), cluster2 (corresponding to RB#16), cluster3 (corresponding to RB#26), cluster4 (corresponding to RB#36), cluster5 (corresponding to RB#46), cluster6 (corresponding to RB#56), cluster7 (corresponding to RB#66), cluster8 (corresponding to RB#76), cluster9 (corresponding to RB#86) and cluster10 (corresponding to RB#96)}.

The resource units in the interleaved unit or cluster or resource block 7 are {cluster1 (corresponding to RB#7), cluster2 (corresponding to RB#17), cluster3 (corresponding to RB#27), cluster4 (corresponding to RB#37), cluster5 (corresponding to RB#47), cluster6 (corresponding to RB#57), cluster7 (corresponding to RB#67), cluster8 (corresponding to RB#77), cluster9 (corresponding to RB#87) and cluster10 (corresponding to RB#97)}.

The resource units in the interleaved unit or cluster or resource block 8 are {cluster1 (corresponding to RB#8), cluster2 (corresponding to RB#18), cluster3 (corresponding to RB#28), cluster4 (corresponding to RB#38), cluster5 (corresponding to RB#48), cluster6 (corresponding to RB#58), cluster7 (corresponding to RB#68), cluster8 (corresponding to RB#78), cluster9 (corresponding to RB#88) and cluster10 (corresponding to RB#98)}.

The resource units in the interleaved unit or cluster or resource block 9 are {cluster1 (corresponding to RB#9), cluster2 (corresponding to RB#19), cluster3 (corresponding to RB#29), cluster4 (corresponding to RB#39), cluster5 (corresponding to RB#49), cluster6 (corresponding to RB#59), cluster7 (corresponding to RB#69), cluster8 (corresponding to RB#79), cluster9 (corresponding to RB#89) and cluster10 (corresponding to RB#99)}.

The indicator value r may be obtained through the starting position (i.e., the serial number of the interleaved unit or cluster or resource block as 0 or 1 or 2 or 3 or 4 or 5 or 6 or 7 or 8 or 9 or 10 described here) of the interleaved units or clusters or resource blocks, and the number of the consecutively allocated interleaved units or clusters or resource blocks. The base station notifies the UE of the indicator value r. The UE can obtain the resource allocation pattern based on the starting position (i.e., the serial number of the interleaved unit or cluster or resource block as 0 or 1 or 2 or 3 or 4 or 5 or 6 or 7 or 8 or 9 or 10 described here) of the interleaved units or clusters or resource blocks, and the number of the consecutively allocated interleaved units or clusters or resource blocks. Furthermore, the resource units included in each interleaved unit or cluster or resource block may be predetermined by the base station and the UE, or may be notified by the base station to the UE through physical-layer DCI signaling, or may be notified to the UE through RRC signaling. In the present embodiment, for the user 1 or the user group 1, the allocated resource pattern is determined and obtained according to the starting position with a value 0 of the interleaved units or clusters or resource blocks and the number with a value 1 of the consecutively allocated interleaved units or clusters or resource blocks, and the corresponding resource pattern allocated to the user 1 or the user group 1 is the resource units in the interleaved unit or cluster or resource block 0, which are {cluster1 (corresponding to RB#0), cluster2 (corresponding to RB#10), cluster3 (corresponding to RB#20), cluster4 (corresponding to RB#30), cluster5 (corresponding to RB#40), cluster6 (corresponding to RB#50), cluster7 (corresponding to RB#60), cluster8 (corresponding to RB#70), cluster9 (corresponding to RB#80) and cluster10 (corresponding to RB#90)}, as illustrated in FIG. 8.

For the user 1 or the user group 1, if the allocated resource pattern is based on the starting position with a value 0 of the interleaved units or clusters or resource blocks and the number with a value of 2 of the consecutively allocated interleaved units or clusters or resource blocks, then the corresponding resource pattern, which is determined and obtained and is allocated to the user 1 or the user group 1, is the frequency domain resources corresponding to: the resource units in the interleaved unit or cluster or resource block 0 which are {cluster1 (corresponding to RB#0), cluster2 (corresponding to RB#10), cluster3 (corresponding to RB#20), cluster4 (corresponding to RB#30), cluster5 (corresponding to RB#40), cluster6 (corresponding to RB#50), cluster7 (corresponding to RB#60), cluster8 (corresponding to RB#70), cluster9 (corresponding to RB#80) and cluster10 (corresponding to RB#90)}, and the resource units in the interleaved unit or cluster or resource block 1 which are {cluster1 (corresponding to RB#1), cluster2 (corresponding to RB#11), cluster3 (corresponding to RB#21), cluster4 (corresponding to RB#31), cluster5 (corresponding to RB#41), cluster6 (corresponding to RB#51), cluster7 (corresponding to RB#61), cluster8 (corresponding to RB#71), cluster9 (corresponding to RB#81), cluster10 (corresponding to RB#91)}.

Similarly, the bitmap may also be used to indicate the resource allocation pattern of the user 1 or the user group 1. For example, there are 10 interleaved units or clusters or resource blocks, and the bitmap 0101000000 is used to indicate that resource positions corresponding to the interleaved unit or cluster or resource block 1 or 3 are allocated to the user 1 or the user group 1, i.e., {cluster1 (corresponding to RB#1), cluster2 (corresponding to RB#11), cluster3 (corresponding to RB#21), cluster4 (corresponding to RB#31), cluster5 (corresponding to RB#41), cluster6 (corresponding to RB#51), cluster7 (corresponding to RB#61), cluster8 (corresponding to RB#71), cluster9 (corresponding to RB#81) and cluster10 (corresponding to RB#91)}, and {cluster1 (corresponding to RB#3), cluster2 (corresponding to RB#13), cluster3 (corresponding to RB#23), cluster4 (corresponding to RB#33), cluster5 (corresponding to RB#43), cluster6 (corresponding to RB#53), cluster7 (corresponding to RB#63), cluster8 (corresponding to RB#73), cluster9 (corresponding to RB#83) and cluster10 (corresponding to RB#93)}. The advantage of using a bitmap is that both consecutive and discrete resource pattern can be flexibly indicated, while the disadvantage of using a bitmap is that bit overheads are high.

Just like the mode 2 in the alternative embodiment two, the value of Y is calculated as follows: Y=Mod(x₁*c₁+L₁*c₂,M), where m₁=14, m₂=9 (where m₁, m₂ are two mutually primes within the number of the available resource configured by the system), M=m₁*m₂=14*9=126, c₁=99, c₂=28, x₁=0, L₁=1. Then Y=Mod(x₁*c₁+L₁*c₂,M)=28. After the user or user group receives the value of Y, decoding is performed using the following equation:

$$\begin{matrix}mod ( Y , {m}_{1} ) = mod ( 28 , 14 ) = 0 = {r}_{1} \\ mod ( Y , {m}_{2} ) = mod ( 28 , 9 ) = 1 = {r}_{2}\end{matrix} .$$

r₁ indicates that the starting point of the allocated Cluster1 is 0. r₂ indicates that the length of the allocated Cluster1 is 1. Overheads for indicating one cluster are

$$⌈ {log}_{2} ( {\prod }_{i = 1}^{2 P} {m}_{i} ) ⌉ = [ {log}_{2} ( {m}_{1} * {m}_{2} ) ] = [ {log}_{2} ( 126 ) ] = 7 bits .$$

Furthermore, it can be known, through the system bandwidth as 20 MHz, that the corresponding period is 10. Based on decoding the resource position corresponding to the first cluster and the period 10, the entire resource pattern allocated to the user can be obtained as: RB#0, RB#10, RB#20, RB#30, RB#40, RB#50, RB#60, RB#70, RB#80 and RB#90. If the size of the clusters of the resource allocation set of other users is also 1 and the number of the clusters is also 10, then it can be known that 10 users can be multiplexed on the 20 MHz system bandwidth.

However, if the period T is not adopted, then 11 values of m (i.e., starting positions of 10 clusters correspond to 10 values of m, and one value of m is required if the lengths of all clusters are same, so a total of 11 parameters of m are required) that are mutually primes need to be defined, and then bit overheads for indicating the allocation pattern for the entire frequency domain are

$$⌈ {log}_{2} ( {\prod }_{i = 1}^{2 P} {m}_{i} ) ⌉ = [ {log}_{2} ( {m}_{1} * {m}_{2} * {m}_{3} * {m}_{4} * {m}_{5} * {m}_{6} * {m}_{7} * {m}_{8} * {m}_{9} * {m}_{10} * {m}_{11} ) ] bits .$$

Apparently, when the period parameter is adopted, system overheads are decreased significantly.

### Alternative Embodiment Eight

FIG. 9 is a schematic diagram seven of resource allocation according to an alternative embodiment of the present disclosure. As illustrated in FIG. 9, in the resource allocation pattern in the present alternative embodiment, the system bandwidth is 20 MHz=100 RBs. According to the existing standard, the number of RBGs available for resource allocation is 25 and the size P of the RBGs is 4. Furthermore, based on the period T, as 4 RBs, of the clusters corresponding to the system bandwidth 20 MHz or the number, as 4, of the multiplexed users, the above resources are divided into 4 resource sets. The first resource set is composed of the first RBs of every RBGs, the second resource set is composed of the second RBs of every RBGs, the third resource set is composed of the third RBs of every RBGs, and the fourth resource set is composed of the fourth RBs of every RBGs. In this way, each resource set includes 25 RBs, and the resource indexes differ by 4 from each other.

In different CCA detection stages, resource allocation patterns are different, and the minimum granularity of resource allocation is consistent with the minimum granularity of a CCA detection pattern. It is assumed here that an equal-interval frequency domain pattern allocated to a certain user is as illustrated in FIG. 9: [RB1, RB5, RB9, RB13, RB17, RB21, RB25, RB29, RB33, RB37, RB41, RB45, RB49, RB53, RB57, RB61, RB65, RB69, RB73, RB77, RB81, RB85, RB89, RB93, RB97].

It can be seen from the allocated pattern that the pattern of the user is composed of RBs in the second resource set. Therefore, the base station only needs to indicate, by using ┌log₂(C₄¹)┐=2 bits information, the UE which resource set the allocated resource are belonged, while does not need to indicate the indicator value corresponding to the resource pattern. This further save overheads.

For the case where the minimum granularity of resource allocation is a subcarrier, a mode same as the above mode can also be adopted.

The following alternative embodiments 9 to 11 will illustrate the process of obtaining a corresponding resource allocation pattern in detail, by way of example, for irregular resource allocation pattern of the frequency domain. Three cases are illustrated mainly: the size of the clusters is fixed while the period T of the clusters is variable; the size of the clusters is variable while the period T of the clusters is fixed; and both the size of the clusters and the period T of the clusters are variable. Here the minimum granularity of resource allocation is still the RB, but is not limited to the RB, and it may also be the granularity of resource allocation in RE level. It may be determined whether the minimum granularity of resource allocation is the RB or the RE according to the minimum granularity of the pattern used for processing the CCA detection when competing for an unlicensed carrier.

### Alternative Embodiment Nine

FIG. 10 is a schematic diagram eight of resource allocation according to an alternative embodiment of the present disclosure. As illustrated in FIG. 10, the present alternative embodiment illustrates the schematic diagram of resource allocation, where, the bandwidth is 5 MHz (25 RBs), the size of the clusters is 2 RBs fixedly while intervals between the clusters are variable, and the number of the clusters is 3.

In the present embodiment, it is assumed that the system bandwidth is 5 MHz=25 RBs, the minimum unit of resource allocation is the RB, and resources allocated to a certain user are [RB0, RB1], [RB8, RB9] and [RB13, RB14]. It can be seen from the allocated resources that the size of the three allocated clusters are the same, then, by adopting the remainder theorem method, values of m1, m2, m3 and m4 need to be defined, and m1=14, m2=9, m3=17 and m4=5. According to the starting resource index of the cluster1 being 0, the starting resource index of the cluster 2 being 8, the starting resource index of the cluster 3 being 13, and the sizes of all clusters being 2, Y=mod (x₁*c₁+x₂*c₂+x₃*c₃+L*c₄,M) is obtained through joint coding, where C1=8415, C2=5950, C3=630, C4=6426, M=10710 and Y=4382. After the UE receives the value of Y, it is decoded using the following equation:

$$\begin{matrix}mod ( Y , {m}_{1} ) = mod ( 4382 , 14 ) = 0 = {r}_{1} \\ mod ( Y , {m}_{2} ) = mod ( 4382 , 9 ) = 8 = {r}_{2} \\ mod ( Y , {m}_{3} ) = mod ( 4382 , 17 ) = 13 = {r}_{3} \\ mod ( Y , {m}_{4} ) = mod ( 4382 , 5 ) = 2 = {r}_{4}\end{matrix} .$$

r₁ indicates that the starting point of the allocated Cluster1 is 0, r₂ indicates that the starting point of the allocated Cluster2 is 8, r₃ indicates that the starting point of the allocated Cluster3 is 13, and r₄ indicates that the sizes of allocated clusters are 2.

The number of bits required by such resource allocation mode is

$$⌈ {log}_{2} ( {\prod }_{i = 1}^{2 P} {m}_{i} ) ⌉ = [ {log}_{2} ( {m}_{1} * {m}_{2} * {m}_{3} * {m}_{4} ) ] = [ {log}_{2} ( 10710 ) ] = 14 bits .$$

However, in the existing standard, the calculation for allocation of discrete resources only allows the case where 2 cluster sets can be allocated to one certain user. Therefore, for the 5 MHz bandwidth, the number of bits required by allocating 2 cluster sets is

$$⌈ {log}_{2} ( ( \begin{matrix}⌈ {N}_{RB}^{UL} / P + 1 ⌉ \\ M\end{matrix} ) ) ⌉ = {log}_{2} ( \begin{matrix}14 \\ 4\end{matrix} ) = 10 bits .$$

In the corresponding DCI format, only 10 bits are allocated to the resource allocation indicator for indicating the resource allocation. While the existing DCI format does not support the case with more than 2 clusters. Therefore, for LTE-U, bit positions used by some indicators for indicating irrelevant to the LTE-U system in the existing protocol may be allocated to the user. For example, if the uplink does not need to perform the power control and adjustment or send a DMRS, then 2 bits allocated to TPC in Format 4 and 3 bits of CS and OCC of DMRS, and so on, may serve as bits for indicating resource positions for multiple clusters. Alternatively, a new format may be defined for the case where multiple clusters exist and the sizes of the clusters or the intervals between the clusters are unequal.

### Alternative Embodiment Ten

FIG. 11 is a schematic diagram nine of resource allocation according to an alternative embodiment of the present disclosure. As illustrated in FIG. 11, in the present alternative embodiment illustrates the schematic diagram of the resource allocation, where, the bandwidth is 5 MHz (25 RBs), the size of the clusters is variable while intervals between the clusters are fixed (i.e., the period is 8 RBs), and the number of the clusters is 3.

In the present embodiment, it is assumed that the system bandwidth is 5 MHz=25 RBs, the minimum unit of resource allocation is the RB, and resources allocated to a certain user are [RB0, RB1], [RB8˜RB10] and [RB16˜RB19]. It can be seen from the allocated resources that the sizes of three allocated clusters are different but the period between each cluster is 8 RBs. The value of r obtained through means 3 is as follows:

$$r = {\sum }_{i = 0}^{{M}^{′} - 1} 〈 \begin{matrix}{N}^{′} - {s}_{i} \\ {M}^{′} - i\end{matrix} 〉 .$$

where, N′=┌N_{RB}^{UL}/P┐+1, and N′ and M′ in the above equation may be different from or the same as N, M and P given in uplink resource allocation in the existing physical layer standard. Here, P is 2, N=┌N_{RB}^{UL}/P┐+1=[25/2]+1=14 and M=6, then

$$r = {\sum }_{i = 0}^{M - 1} 〈 \begin{matrix}N - {s}_{i} \\ M - i\end{matrix} 〉 = {\sum }_{i = 0}^{5} 〈 \begin{matrix}14 - {s}_{i} \\ 6 - i\end{matrix} 〉 = 〈 \begin{matrix}14 \\ 6\end{matrix} 〉 + 〈 \begin{matrix}13 \\ 5\end{matrix} 〉 + 〈 \begin{matrix}10 \\ 4\end{matrix} 〉 + 〈 \begin{matrix}8 \\ 3\end{matrix} 〉 + 〈 \begin{matrix}6 \\ 2\end{matrix} 〉 + 〈 \begin{matrix}4 \\ 1\end{matrix} 〉 = 4575.$$

In this case,

$$⌈ {log}_{2} ( ( \begin{matrix}⌈ {N}_{RB}^{UL} / P + 1 ⌉ \\ M\end{matrix} ) ) ⌉ = {log}_{2} ( \begin{matrix}14 \\ 6\end{matrix} ) = 12 bits$$

are required for transmitting the resource indicator value.

For the case where the size of the clusters is less than an integral multiple of the size of the RBG, bits may be increased to indicate in which cluster the rear one or more RBs in the RBG corresponding to the ending position are vacant. Alternatively, the system bandwidth may also correspond to the clusters by defining the clusters of which the size is less than the integral multiple of the size of the RBG. For example, the 5 MHz corresponds to three clusters, and the last RB in the RBG corresponding to the ending position index of the second cluster is vacant. The latter does not increase bit overheads.

While, if the remainder theorem method is adopted, values of m1, m2, m3, m4 and m5 need to be defined, and m1=13, m2=7, m3=19, m4=5 and m5=11. According to the starting resource index of the cluster 1 being 0, the size of the cluster 1 being 2, the size of the cluster 2 being 3, the size of the cluster 3 being 4, and the interval between the clusters being 8, Y=mod (x₁*c₁+x₂*c₂+x₃*c₃+x₄*c₄+T*c₅,M) is obtained through the joint coding, where C1=21945, C2=40755, C3=60060, C4=76076, C5=86450, M=95095 and Y=21359. After the UE receives the value of Y, it is decoded using the following equation:

$$\begin{matrix}mod ( Y , {m}_{1} ) = mod ( 21359 , 13 ) = 0 = {r}_{1} \\ mod ( Y , {m}_{2} ) = mod ( 21359 , 7 ) = 2 = {r}_{2} \\ mod ( Y , {m}_{3} ) = mod ( 21359 , 19 ) = 3 = {r}_{3} \\ mod ( Y , {m}_{4} ) = mod ( 21359 , 5 ) = 4 = {r}_{4} \\ mod ( Y , {m}_{5} ) mod ( 21359 , 11 ) = 8 = {r}_{5}\end{matrix} .$$

r₁ indicates that the starting point of the allocated Cluster1 is 0, r₂ indicates that the size of the allocated Cluster1 is 2, r₃ indicates that the size of the allocated Cluster2 is 3, and r₄ indicates that the size of the allocated Cluster2 is 4, and r₅ indicates that the interval between starting positions of the clusters is 8. The number of bits required by such resource allocation mode is

$$⌈ {log}_{2} ( {\prod }_{i = 1}^{2 P} {m}_{i} ) ⌉ = [ {log}_{2} ( {m}_{1} * {m}_{2} * {m}_{3} * {m}_{4} * {m}_{5} ) ] = [ {log}_{2} ( 95095 ) ] = 17 bits .$$

The number of bits required for the above two resource allocation indication modes is several bits more than the number of bits required for the resource allocation indicator in the existing standard. Bit positions used by some indicators for indicating irrelevant to the LTE-U system in the existing protocol may be allocated to the user. For example, if the uplink does not need to perform the power control and adjustment or send the DMRS, then 2 bits allocated to TPC in Format 4 and 3 bits of CS and OCC of DMRS, and so on, may serve as bits for indicating resource positions for multiple clusters. Alternatively, a new format may be defined for the case where multiple clusters exist and the sizes of the clusters or the intervals between the clusters are unequal. Alternatively, for the remainder theorem mode, multiple values of m, that are mutually primes, may be appropriately selected furthermore.

### Alternative Embodiment Eleven

FIG. 12 is a schematic diagram ten of resource allocation according to an alternative embodiment of the present disclosure. As illustrated in FIG. 12, in the present alternative embodiment illustrates the schematic diagram of the resource allocation, where, the system bandwidth is 5 MHz (25 RBs), the size of the clusters is variable while intervals between the clusters are variable as well, and the number of the clusters is 3.

In the present embodiment, it is assumed that the system bandwidth is 5 MHz=25 RBs, the minimum unit of resource allocation is the RB, and resources allocated to a certain user are [RB0, RB1], [RB6˜RB8] and [RB14˜RB17]. It can be seen from the allocated resources that the sizes of three allocated clusters are different and the intervals between the clusters are variable as well. The value of r obtained through mode three is as follows:

$$r = {\sum }_{i = 0}^{{M}^{′} - 1} 〈 \begin{matrix}{N}^{′} - {s}_{i} \\ {M}^{′} - i\end{matrix} 〉 .$$

N′=┌N_{RB}^{UL}/P┐+1, and N′ and M′ in the above equation may be different from or the same as N, M and P given in uplink resource allocation in the existing physical layer standard. Here, P is 2, N=┌N_{RB}^{UL}/P┐+1=[25/2]+1=14 and M=6, then

$$r = {\sum }_{i = 0}^{M - 1} 〈 \begin{matrix}N - {s}_{i} \\ M - i\end{matrix} 〉 = {\sum }_{i = 0}^{5} 〈 \begin{matrix}14 - {s}_{i} \\ 6 - i\end{matrix} 〉 = 〈 \begin{matrix}14 \\ 6\end{matrix} 〉 + 〈 \begin{matrix}13 \\ 5\end{matrix} 〉 + 〈 \begin{matrix}11 \\ 4\end{matrix} 〉 + 〈 \begin{matrix}9 \\ 3\end{matrix} 〉 + 〈 \begin{matrix}7 \\ 2\end{matrix} 〉 + 〈 \begin{matrix}5 \\ 1\end{matrix} 〉 = 4730.$$

In this case,

$$⌈ {log}_{2} ( ( \begin{matrix}⌈ {N}_{RB}^{UL} / P + 1 ⌉ \\ M\end{matrix} ) ) ⌉ = {log}_{2} ( \begin{matrix}14 \\ 6\end{matrix} ) = 12 bits$$

are required for transmitting the resource indicator value. Just like the alternative embodiments 10 and 11, in the case where the existing DCI format is insufficient for indicating the number of bits used by 3 clusters, a new format may be defined or bits occupied by relevant parameters which may be different for the LTE-U may be allocated to resource indication bits of multiple clusters.

Further, for the case where the size of the clusters is less than an integral multiple of the size of the RBG, bits may be increased to indicate in which cluster the rear one or more RBs in the RBG corresponding to the ending position are vacant. Alternatively, the system bandwidth may also correspond to the clusters by defining the clusters of which the size is less than the integral multiple of the size of the RBG. For example, the 5 MHz corresponds to three clusters, and the last RB in the RBG corresponding to the ending position index of the second cluster is vacant. The latter does not increase bit overheads.

Similarly, for the system bandwidth being 10 MHz, 15 MHz and 20 MHz, it can be realized by adopting the above means.

From the description of the embodiments described above, it will be apparent to those skilled in the art that the method of any embodiment described above may be implemented by means of software plus necessary general-purpose hardware, or may of course be implemented by hardware, but in many cases the former is a preferred embodiment. Based on this understanding, the present disclosure may be embodied in the form of a software product. The software product is stored in a storage medium (such as a ROM/RAM, a magnetic disk or an optical disk) and includes several instructions for enabling a terminal device (which may be a mobile phone, a computer, a server or a network device) to execute the method according to each embodiment of the present disclosure.

Another embodiment of the present disclosure provides a storage medium.

Alternatively, in the present embodiment, the storage medium may be configured to store program codes for executing the steps in the embodiments described above.

Alternatively, in the present embodiment, the storage medium may include, but not limited to, a U disk, a read-only memory (ROM), a random-access memory (RAM), a mobile hard disk, a magnetic disk, an optical disk or another medium capable of storing program codes.

It will be understood by those of ordinary skill in the art that all or part of the steps in the methods described above may be implemented by related hardware (e.g., a processor) instructed by one or more programs, and these programs may be stored in a computer-readable storage medium such as a ROM, a magnetic disk, an optical disk or the like. Alternatively, all or part of the steps in the embodiments described above may also be implemented using one or more integrated circuits. Accordingly, the modules/units in the embodiments described above may be implemented by hardware. For example, the functions of these modules/units may be implemented by one or more integrated circuits. Alternatively, these modules/units may be implemented by software function modules. For example, the functions of these modules/units may be implemented by using a processor to execute program instructions stored in a storage medium. The present application is not limited to any specific combination of hardware and software.

The present application may have other various embodiments. Corresponding changes and modifications may be made by those skilled in the art according to the present application without departing from the spirit and essence of the present application. However, these corresponding changes and modifications fall within the scope of the claims in the present application.

### INDUSTRIAL APPLICABILITY

In the embodiments of the present disclosure, the spectrum resource allocation method includes determining a resource allocation pattern of nodes according to a preset parameter, wherein the preset parameter comprises at least one of: a starting position of a frequency domain or an offset of the frequency domain, an ending position of the frequency domain, a length of consecutively allocated resources or a size of consecutively allocated clusters, a number of clusters or a number of resource sets, a period T, a number of multiplexing nodes in frequency domain resources, or a number of allocatable resources in a system; and obtaining a corresponding resource allocation indicator value r by the resource allocation pattern determined by at least one of the preset parameters in a preset encoding mode. The resource allocation indicator value r is used for indicating resource position information allocated to a terminal UE. The solution solves problems of poor flexibility, high overheads and low frequency diversity gains in resource allocation caused by a limitation where at most two clusters may be allocated to each user. The method provided by embodiments of the present disclosure may be used to allocate multiple clusters (more than two clusters) to each UE flexibly, thereby increasing flexibility, reducing overheads and improving frequency diversity gains in resource allocation.

1. A spectrum resource allocation method comprising:
determining a resource allocation pattern of nodes according to a preset parameter, wherein the preset parameter comprises at least one of:
a starting position of a frequency domain or an offset of the frequency domain, an ending position of the frequency domain, a length of consecutively allocated resources or a size of consecutively allocated clusters, a number of clusters or a number of resource sets, a period, a number of multiplexing nodes in frequency domain resources, or a number of allocatable resources in a system; and
obtaining a resource allocation indicator value by at least one of the preset parameters in a preset encoding mode, wherein the resource allocation indicator value is used for indicating resource position information allocated to a terminal UE,
wherein the method is performed by one or more processors.

2. The method of claim 1, wherein the number of the allocatable resources in the system is divided into a first number of interleaved units, a first number of clusters, or a first number of resource blocks; and wherein the first number is the period.

3. The method of claim 2, wherein each of the interleaved units or clusters or resource blocks comprises a second number of resource units; and wherein the resource units are resource blocks (RBs) or resource elements (REs) or resource block groups (RBGs) or sub-bands.

4. The method of claim 3, wherein between the resource units in each of the interleaved units or clusters or resource blocks include intervals of specific values; or between the resource units in each of the interleaved units or clusters or resource blocks include consecutive resource blocks.

5. The method of claim 4, wherein the intervals between the resource units are equal intervals or unequal intervals.

6. The method of claim 5, wherein in response to determining that the intervals between the resource units are equal, each of the intervals is the period.

7. The method of claim 3, wherein between the interleaved units or between the clusters or between the resource blocks, between resource units of the same resource unit index have a specific offset.

8. The method of claim 7, wherein the minimum of the offset is zero, the maximum of the offset is the first number or the second number or a preset number.

9. The method of claim 2, wherein the period is at least one of: 1, 2, 3, 4, 5, 6, 7, 8, 9 or 10; and
wherein a unit of the period is resource block (RB) or resource element (RE) or resource block group (RBG) or sub-band.

10. The method of claim 2, wherein the number of the allocatable resources in the system is at least one of: 100, 75, 50 or 25; and
wherein a unit of the allocatable resources in the system is RB.

11. The method of claim 3, wherein the second number is obtained by dividing the number of the allocatable resources in the system by the period.

12. (canceled)

13. (canceled)

14. The method of claim 1, wherein the resource allocation pattern comprises: a resource allocation pattern wherein the minimum granularity of resource allocation includes a resource block (RB), or a resource allocation pattern wherein the minimum granularity of resource allocation includes a resource element (RE); and
wherein the minimum granularity of resource allocation is related to a granularity of a clear channel assessment (CCA) detection pattern.

15. The method of claim 14, wherein
the minimum granularity of resource allocation is consistent with the minimum granularity of the CCA detection pattern; or
the minimum granularity of resource allocation is inconsistent with the minimum granularity of the CCA detection pattern.

16. The method of claim 15, wherein the resource allocation indicator value is used for the terminal UE obtaining the allocated resource position information through corresponding decoding according to the resource allocation indicator value, and
the resource position information comprises:
the starting position of the frequency domain, and the length of the consecutively allocated resources;
the starting position of the frequency domain, and the size of the consecutively allocated clusters;
a starting position of interleaved units or clusters or resource blocks, and a number of consecutively allocated interleaved units or clusters or resource blocks;
the starting position of the frequency domain, and the ending position of frequency domain resources; or
a starting position of the interleaved units or clusters or resource blocks, and an ending position of the interleaved units or clusters or resource blocks.

17. The method of claim 1, wherein:
at least one of the period of the clusters, the number of the multiplexing nodes, the number of the clusters, a first number, a second number, intervals, the offset, or a preset number in the resource allocation pattern is obtained by:
obtaining through a corresponding relationship with a system bandwidth;
obtaining through a downlink control information (DCI) indication;
obtaining through preset value(s); or
obtaining through value(s) configured by a base station or high layer signaling.

18. The method of claim 1, wherein the method further includes:
determining the resource allocation indicator value through the starting position of the frequency domain and the length of the consecutively allocated resources; the starting position of the frequency domain and the size of the consecutively allocated clusters; or the starting position of interleaved units or clusters or resource blocks, the number of consecutively allocated interleaved units or clusters or resource blocks and the number of the allocatable resources, wherein determining the resource allocation indicator value comprises at least one of the following modes:
mode 1:
in response to determining that, for the resource allocation pattern, minimum granularity of resource allocation is RB:
in response to determining that (L_{CRBs}−1)≤└N_{RB}^{UL}/2┘, then RIV=N_{RB}^{UL} (L_{CRBs}−1)+RB_{START},
in response to determining that (L_{CRBs}−1)>└N_{RB}^{UL}/2┘, then RIV=N_{RB}^{UL}(N_{RB}^{UL}−L_{CRBs}+1)+(N_{RB}^{UL}−1−RB_{START}),
wherein:
L_{CRBs} denotes the length of the consecutively allocated resources or a number of interleaved units or a number of clusters or a number of resource blocks when the minimum granularity of resource allocation is the RB,
N_{RB}^{UL} denotes the number of the allocatable resources when the minimum granularity of resource allocation is the RB,
RB_{START} denotes the starting position of the frequency domain or the starting position of the interleaved units or the starting position of the clusters or the starting position of the resource blocks when the minimum granularity of resource allocation is the RB, and
RIV denotes the resource allocation indicator value;
in response to determining that, for the resource allocation pattern, the minimum granularity of resource allocation is RE,
in response to determining that (L_{Carrier}−1)≤└N_{Carrier}/2┘, then C_RIV=N_{Carrier}(L_{Carrier}−1)+C_{START},
in response to determining that (L_{Carrier}−1)>└N_{Carrier}/2┘, then C_RIV=N_{Carrier}(N_{Carrier}−L_{Carrier}+1)+(N_{Carrier}−1−C_{START}),
wherein:
N_{Carrier} denotes the number of the allocatable resources when the minimum granularity of resource allocation is the RE,
L_{Carrier} denotes the length of the consecutively allocated resources or the number of the interleaved units or the number of the clusters or the number of the resource blocks when the minimum granularity of resource allocation is the RE,
C_{START} denotes the starting position of the frequency domain or the starting position of the interleaved units or the starting position of the clusters or the starting position of the resource blocks when the minimum granularity of resource allocation is the RE, and
C_RIV denotes the resource allocation indicator value;
mode 2:
in response to determining that, for the resource allocation pattern, the minimum granularity of resource allocation is RB or RE,
Y=Mod(x₁*c₁+x₂*c₂,M),
wherein:
x₁ denotes a starting resource index of a first resource set Cluster, or a starting position index of interleaved units, or a starting position index of clusters or a starting position index of resource blocks,
x₂ denotes the length of consecutively allocated resources of the first resource set Cluster, or the number of the interleaved units, or the number of the clusters, or the number of the resource blocks,
M=m₁*m₂,
m₁, m₂ are mutually prime that is configured by the system by a static or semi-static mode, and m₁,m₂ are mutually prime within the number of the available resources,
$${c}_{i} = \frac{M}{{m}_{i}} * {( \frac{M}{{m}_{i}} )}^{′} , i = 1 , 2 and {( \frac{M}{{m}_{i}} )}^{′}$$
is a smallest positive integer of satisfying mod(cᵢ,mᵢ)=1,
wherein Y denotes the resource allocation indicator value.

19. The method of claim 16, wherein the resource allocation indicator value is determined by at least one of the ending position of frequency domain, the starting position of the frequency domain or the offset of the frequency domain; or is determined by the starting position of the interleaved units or clusters or resource blocks, and the ending position of the interleaved units or clusters or resource blocks, comprising:
$${r}^{′} = {\sum }_{i = 0}^{{M}^{′} - 1} 〈 \begin{matrix}{N}^{′} - {s}_{i} \\ {M}^{′} - i\end{matrix} 〉$$
wherein:
sᵢ denotes an index of a starting RB or RE resource of frequency domain resources of a resource set Cluster allocated to a user, or a starting position index of the interleaved units or clusters or resource blocks;
sᵢ−1 denotes an index of an ending RB or RE resource of the frequency domain resources of the resource set Cluster allocated to the user, and i=0, 1, or an ending position index of the interleaved units or clusters or resource blocks;
M′ denotes the number of the starting and ending of the resource set Cluster or the interleaved units or clusters or resource blocks;
N′=┌N_{RB}^{UL}/P┐+1;
P denotes a size of a resource block group (RBG), and P is configured according to a corresponding relationship with a system bandwidth or according to resource allocation requirements;
r′ denotes the resource allocation indicator value.

20. (canceled)

21. (canceled)

22. (canceled)

23. (canceled)

24. The method of claim 18, wherein the method further includes:
transmitting, by a base station, the resource allocation indicator value to the terminal UE by low bit overheads for the terminal UE obtaining the resource allocation pattern in the entire available resources; or, obtaining the resource allocation pattern with equal interval in the entire available resources by at least one of the period of the clusters, the number of the available resources or the number of the clusters.

25. The method of claim 1, wherein a bitmap is used to indicate the resource allocation pattern in all available resources or the resource position information allocated to the terminal UE.

26. A spectrum resource allocation apparatus, comprising:
a determiner configured to determine a resource allocation pattern of nodes according to a preset parameter, wherein the preset parameter comprises at least one of:
a starting position of a frequency domain or an offset of the frequency domain, an ending position of the frequency domain, a length of consecutively allocated resources or a size of consecutively allocated clusters, a number of clusters or a number of resource sets, a period, a number of multiplexing nodes in frequency domain resources, or a number of allocatable resources in a system; and
an obtainer configured to obtain a resource allocation indicator value by at least one of the preset parameters in a preset encoding mode, wherein the resource allocation indicator value is used for indicating resource position information allocated to a terminal UE.
